(19) United States
(12) Patent Application Publication
(10) Pub. No.: US 2025/0030808 A1
(43) Pub. Date: Jan. 23, 2025

(54) IMAGE PROCESSING APPARATUS, METHOD OF CONTROLLING THE SAME, AND STORAGE MEDIUM

(71) Applicant: CANON KABUSHIKI KAISHA, Tokyo (JP)

(72) Inventor: NAOKI MARUYAMA, Tokyo (JP)

(21) Appl. No.: 18/775,464

(22) Filed: Jul. 17, 2024

(30) Foreign Application Priority Data
Jul. 18, 2023 (JP) 2023-116925

(51) Int. Cl. H04N 1/00; G09B 7/00

(52) U.S. Cl. CPC H04N 1/00973; G09B 7/00

(57) ABSTRACT

Embodiments of the present disclosure are directed to an image processing apparatus comprising: an obtaining unit configured to obtain a scoring module that executes electronic scoring processing and an operation module that displays a screen for electronic scoring and accepts a user operation; a reading unit configured to read an answer sheet to be electronically scored; and an output unit configured to output image data read by the reading unit and output data including the scoring module and the operation module.

### BACKGROUND

### Field of the Disclosure

The present disclosure relates to an image processing apparatus, a method of controlling the same, and a storage medium.

### Description of the Related Art

Systems in which a sheet of printed material that has been filled in is read by a scanner and the read image is displayed on a device, such as a PC, and is processed according to user input are known. For example, there are electronic scoring applications (hereinafter referred to as applications) for performing electrical scoring using read images of test answer sheets.

When such applications are executed, cases where the application is installed and executed on a particular computer or executed by accessing an application service on the cloud, for example, are conceivable. However, when a plurality of computers can be used, it is necessary to know on which computer the application is installed. If that is unknown, it is necessary to activate each computer and confirm whether or not the application is installed, which is inconvenient. Further, if access to an external network is restricted, it is conceivable that an application service on the cloud cannot be accessed. Even if the application could be installed on a scanner, if there a plurality of scanners, inconvenience similar to that of computers described above arises. Japanese Patent Laid-Open No. 2006-288720 proposes storing slice image data sliced from three-dimensional CT data and writing out, to a medium, a display program for displaying the slice image data using a computer.

However, the above-described conventional technique has the following issues. In the above-described conventional technique, the slice image data is provided together with the dedicated display program, and so, it is possible to display CT image slices on a plurality of computers. However, in the above-described conventional technique, the main focus is to display image data, and it is not possible to perform processing, such as electronic scoring, based on the displayed image data. Further, it is not possible to store a partly completed scoring result, which is necessary when performing electronic scoring. Further, in electronic scoring, there is a demand for sharing read image data, scoring results, and the like between a plurality of computers and scanners.

### SUMMARY

Embodiments of the present disclosure enable realization of a system in which a read image obtained by reading an answer sheet and a module that supports electronic scoring are bundled together. Further, embodiments of the present disclosure enable realization of a system in which, for example, when electronic scoring is executed, a scoring result is suitably shared.

Some embodiments of the present disclosure provide an image processing apparatus comprising: an obtaining unit configured to obtain a scoring module that executes electronic scoring processing and an operation module that displays a screen for electronic scoring and accepts a user operation; a reading unit configured to read an answer sheet to be electronically scored; and an output unit configured to output image data read by the reading unit and output data including the scoring module and the operation module.

Some embodiments of the present disclosure provide a method of controlling an image processing apparatus, the method comprising: obtaining a scoring module that executes electronic scoring processing and an operation module that displays a screen for electronic scoring and accepts a user operation; reading an answer sheet to be electronically scored; and outputting image data read in the reading and outputting data including the scoring module and the operation module.

Some embodiments of the present disclosure provide a non-transitory computer-readable storage medium storing one or more programs including instructions, which when executed by one or more processors of an image processing apparatus, cause the image processing apparatus to perform: obtaining a scoring module that executes electronic scoring processing and an operation module that displays a screen for electronic scoring and accepts a user operation; reading an answer sheet to be electronically scored; and outputting image data read in the reading and outputting data including the scoring module and the operation module.

Further features of the present disclosure will become apparent from the following description of exemplary embodiments (with reference to the attached drawings).

### BRIEF DESCRIPTION OF THE DRAWINGS

FIG. 1 is a diagram illustrating examples of hardware configurations of an image processing apparatus and an information device according to an embodiment.

FIGS. 2A to 2F are a diagram illustrating an example of a home screen to be displayed on an LUI of an electronic scoring application according to the embodiment.

FIG. 3 is a diagram illustrating an example of data to be outputted at the time of scanning according to the embodiment.

FIGS. 4A to 4D are a diagram illustrating examples of display pages of the electronic scoring application according to the embodiment.

FIGS. 5A to 5F are a diagram illustrating examples of frame setting pages of the electronic scoring application according to the embodiment.

FIGS. 6A to 6E are a diagram illustrating examples of scoring pages and examples of score setting pages of the electronic scoring application according to the embodiment.

FIGS. 7A to 7B are a diagram illustrating examples of scoring result holding structures of the electronic scoring application according to the embodiment.

FIGS. 8A to 8D are flowcharts for explaining processing procedures for when an answer sheet is scanned in the image processing apparatus according to the embodiment.

FIG. 9 is a flowchart for explaining a processing procedure at the time of drawing of a top page of the electronic scoring application according to the embodiment.

FIGS. 10A to 10D are a diagram illustrating examples of display pages of the electronic scoring application according to the embodiment.

FIGS. 11A to 11C are flowcharts for explaining processing procedures for display control of the electronic scoring application according to the embodiment.

FIGS. 12A to 12F are a diagram illustrating examples of display pages of the electronic scoring application according to the embodiment.

FIG. 13 is a flowchart for explaining a processing procedure at the time of operation of an import button of the electronic scoring application according to the embodiment.

FIGS. 14A to 14C are flowcharts for explaining procedures for merge processing of the electronic scoring application according to the embodiment.

FIGS. 15A to 15D are flowcharts for explaining procedures for frame information merge processing of the electronic scoring application according to the embodiment.

FIGS. 16A and 16B are flowcharts for explaining procedures for comment information merge processing of the electronic scoring application according to the embodiment.

FIGS. 17A to 17F are a diagram illustrating examples of display pages of an RUI of the image processing apparatus according to the embodiment.

FIGS. 18A and 18B are flowcharts for explaining procedures for processing related to the RUI of the image processing apparatus according to the embodiment.

FIGS. 19A and 19B are flowcharts for explaining procedures for processing related to test registration according to the embodiment.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to that require all such features, and multiple such features may be combined as appropriate. Furthermore, in the attached drawings, the same reference numerals are given to the same or similar configurations, and redundant description thereof is omitted.

### First Embodiment

### <System Configuration>

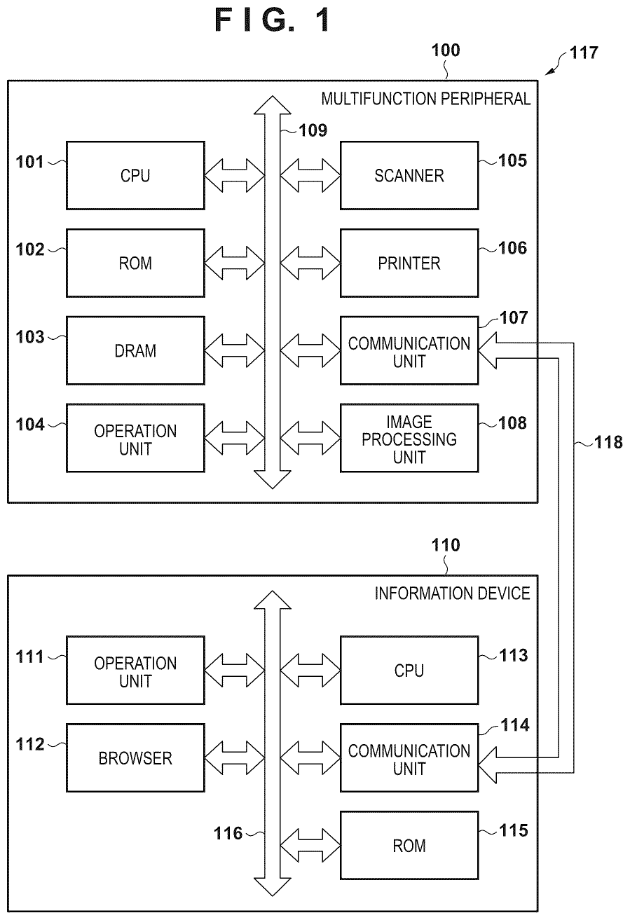

First, a configuration example of a system according to the present embodiment will be described with reference to FIG. 1. A system 117 according to the present embodiment is configured to include a multifunction peripheral 100 and an information device 110, and the apparatuses are connected to each other via a network 118 so as to be able to communicate with each other. In the present embodiment, a multifunction peripheral (MFP) 100 will be given as an example of an image processing apparatus. However, the present disclosure is not intended to be limited thereto, and a printing apparatus, a copying machine, a facsimile apparatus, or the like may be used. Further, the system according to the present embodiment may include other image processing apparatuses, information apparatuses, and the like. The information device 110 is an information terminal such as a PC, a smart phone, or a tablet owned by a user. A user can access the multifunction peripheral 100 from the user's own information device 110 to confirm various kinds of information and use services.

The multifunction peripheral 100 provides various services to each information device that is connected via the network 118 so as to be able to communicate therewith. For example, the multifunction peripheral 100 may provide services such as printing, scanning, SEND, and image analysis. Here, “image analysis” refers to analysis of print data for printing a printed material and analysis of a read image obtained by reading a printed sheet. For example, it is possible to analyze regions to be filled in on a printed material on which predetermined items are printed and, by using a result of that analysis and a read image obtained by reading a filled-in sheet, provide a system for confirming business forms, application forms, and the like or an electronic scoring service. The “electronic scoring service” refers to a service for electronically performing scoring on a screen on which a read image obtained by reading a test answer sheet is displayed. According to the present embodiment, one or more predetermined regions such as an answer field, a subtotal score, a total score, and the like are analyzed in advance, and electronic scoring is performed using a read image obtained by reading the answer sheet after the test is taken and analysis information (scoring data) obtained by performing the analysis in advance. Thereafter, an answer sheet reflecting the scoring results, aggregation data, and the like is printed. Hereinafter, a rectangular shape will be described as an example of the above-described predetermined regions, but the shape is not particularly limited. Further, the term “frame” described below indicates an outer edge of a predetermined region. By setting a score in association with an answer field, it is possible to automatically output a subtotal score or a total score after electronic scoring. As a result, in the electronic scoring, the scorer can reduce work related to the scoring since the score will be automatically outputted simply by scoring the questions.

The multifunction peripheral 100 includes a CPU 101, a ROM 102, a DRAM 103, an operation unit 104, a scanner 105, a printer 106, a communication unit 107, and an image processing unit 108. The CPU 101 is a system control unit that controls the entire apparatus. In addition, the CPU 101 reads and executes a control program stored in the ROM 102. The ROM 102 is composed of a flash memory such as an eMMC and stores a control program of the CPU 101, image data, and the like. The DRAM 103 is a volatile memory that can temporarily store program control variables, image data to be processed, and the like. The ROM 102 and the DRAM 103 can also store frames obtained by analyzing the print data and region information indicating attributes thereof, which will be described below.

The operation unit 104 is a user interface unit that displays internal information of the multifunction peripheral 100 and receives user input via the displayed screens. The scanner 105 is a device that reads image data and converts the image data into binary data, and is used to read a document for an image send function and the like. The printer 106 is a device that performs fixing temperature control to fix an image according to print data onto a sheet, and then outputs the sheet.

The communication unit 107 is an interface unit between the multifunction peripheral 100 and an external communication network, and includes a network communication unit that is an interface to the network and a USB flash memory control unit that inputs to and outputs from a USB flash memory. The image processing unit 108 is configured to include an ASIC that performs image processing such as resolution conversion, compression/decompression, and rotation on the input image data and the output image data. The respective control units are connected to each other via a data bus 109, and can exchange data thereby with each other.

The information device 110 activates the electronic scoring application and performs electronic scoring according to user input. The information device 110 includes an operation unit 111, a browser 112, a CPU 113, a communication unit 114, and a ROM 115. The operation unit 111 is a user interface unit that displays internal information. Depending on the configuration of the information device 110, it also serves the function of accepting user input. The browser 112 is a module that interprets HyperText Markup Language (HTML) and scripts and presents results to a user. By using the browser 112, it is possible to browse and edit data such as text and images. The CPU 113 is a system control unit that controls the entire apparatus. The communication unit 114 is an interface unit between the device and an external communication network. The communication unit 114 includes a network communication unit that is an interface to the network, and a USB flash memory control unit that inputs to and outputs from a USB flash memory. The ROM 115 is composed of a flash memory such as an eMMC and stores a control program of the CPU 113, image data, and the like. The control units and modules are connected to each other via a data bus 116. In the system 117, the multifunction peripheral 100 and the information device 110 are connected via the network 118. By this, a user can access the multifunction peripheral 100 from the user's own information device 110 to confirm various kinds of information.

### <LUI Screen Example>

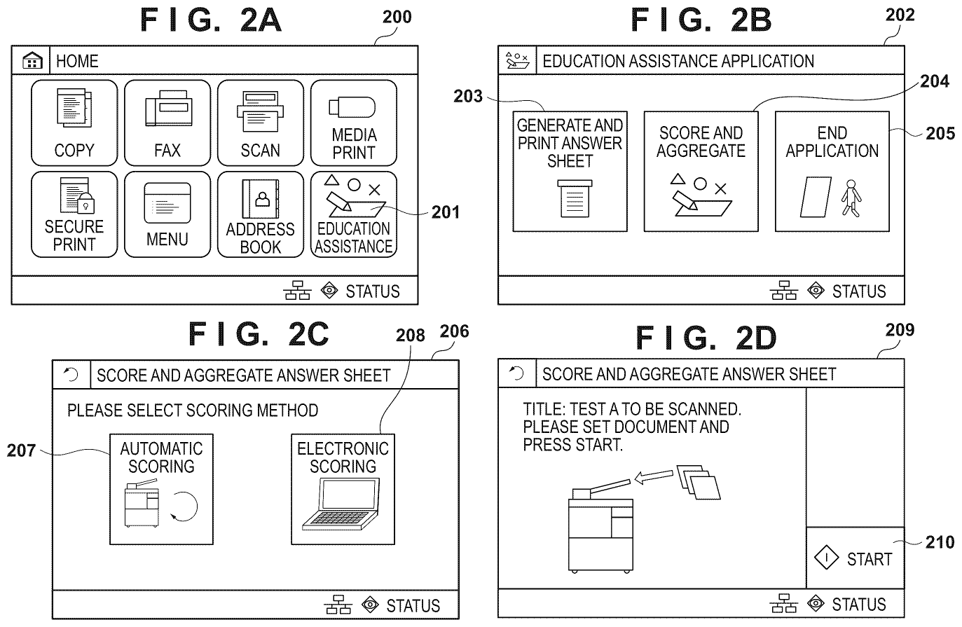

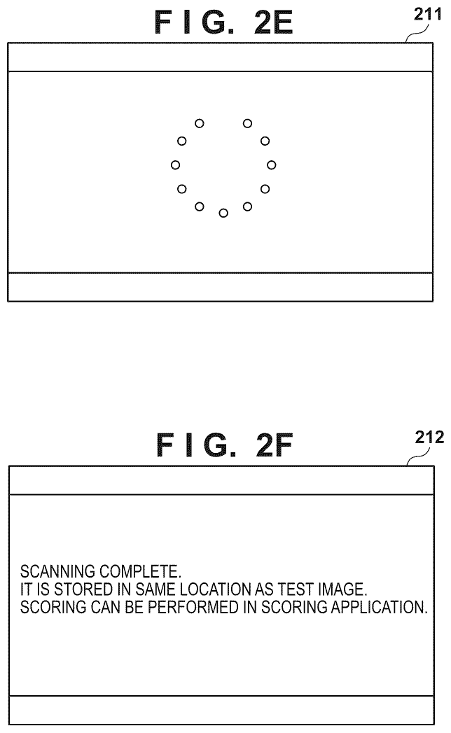

Next, referring to FIGS. 2A-2F, LUI screens of the electronic scoring application displayed on the operation unit 104 of the multifunction peripheral 100 according to the present embodiment will be described. LUI is an abbreviation of Local User Interface. A screen 200 is mainly displayed on the operation unit 104 immediately after the multifunction peripheral 100 is activated, and the user can select an icon displayed on the screen 200 to cause a screen registered for the icon to be displayed and use the function thereof. For example, by selecting an education assistance icon 201, a screen for performing an operation related to the education assistance application can be displayed.

A screen 202 illustrates an example of a screen displayed when the electronic scoring application is activated by selecting the education assistance icon 201. The screen 202 includes a generate and print answer sheet button 203, a score and aggregate button 204, and an end application button 205. When the generate and print answer sheet button 203 is operated, answer sheet generation and printing can be executed using the operation unit 104. When the score and aggregate button 204 is operated, a transition is made to a screen 206 for performing scanning and scoring of a completed answer sheet. When the end application button 205 is operated, the education assistance application can be ended.

The screen 206 illustrates an example of a screen that is displayed on the operation unit 104 of the multifunction peripheral 100 and that is for selecting a scoring method. When an automatic scoring button 207 is operated, a scanned image that is scanned by the scanner 105 is automatically scored and aggregation processing is performed. When an electronic scoring button 208 is operated, a transition is made to a screen 209 for selecting a test to be electronically scored.

The screen 209 illustrates an example of a screen that is displayed on the operation unit 104 of the multifunction peripheral 100 and that is for scanning a test answer sheet to be electronically scored. When a start button 210 is operated, the answer sheet is scanned using the scanner 105.

A screen 211 illustrates an example of a screen that is displayed on the operation unit 104 of the multifunction peripheral 100 while scanning a test answer sheet to be electronically scored. The screen 211 is displayed until scanning is completed. After the scanning is complete, a transition is made to a screen 212 automatically. On the screen 212, a message indicating that scanning is complete and that electronic scoring is possible is displayed. When the scanning is completed, the screen 212 is automatically displayed for a predetermined time, and then a transition to the screen 202 is made automatically.

<Output from Image Processing Apparatus>

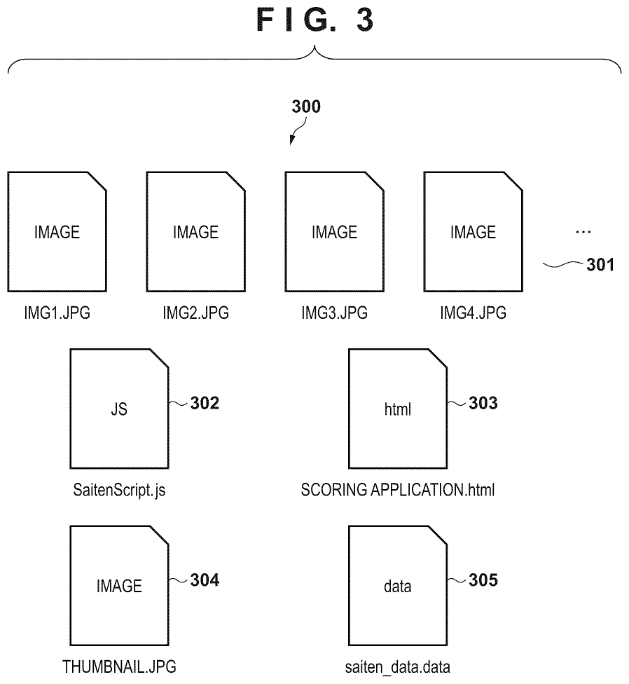

Next, an example of output data 300 outputted when an answer sheet is scanned for electronic scoring will be described with reference to FIG. 3. Read images 301 are read images of students' answer sheets scanned using the scanner 105. The output data 300 includes the read images 301, an electronic scoring module 302, an electronic scoring html 303, a thumbnail image 304, and electronic scoring data 305.

The read images 301 are image data outputted when answer sheets are read using the scanner 105, for example. The electronic scoring module 302 is a scoring module in which processing for executing electronic scoring processing is described and is generated in a script file (application) format, for example. The electronic scoring html 303 is an operation module for displaying screens for electronic scoring and for accepting user operations and is generated in an html file format, for example. Accordingly, the electronic scoring application is constituted by the electronic scoring module 302 and the electronic scoring html 303. The thumbnail image 304 is an image that makes it easier to recognize a test to be electronically scored. The thumbnail image 304 is generated from a read image 301.

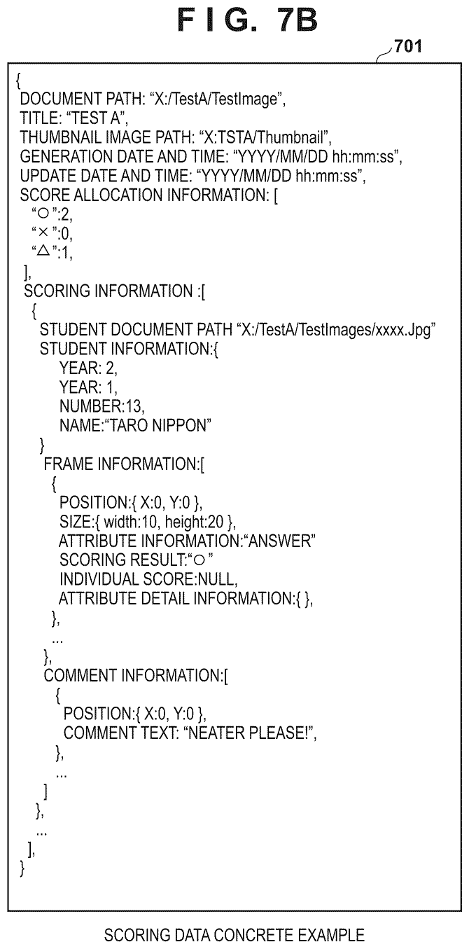

The electronic scoring data 305 is data for holding an electronic scoring result when electronic scoring is performed. Accordingly, regarding the electronic scoring data 305, corresponding data is generated for each test. According to the present embodiment, for example, when an answer sheet is read, the electronic scoring data 305 is outputted as scoring data corresponding to target test data. Details of electronic scoring data will be described later with reference to FIGS. 7A-7B. The output data 300 may be outputted to an external apparatus, such as the information device 110, via the communication unit 107 or may be outputted to an external memory, such as a USB memory. Further, the output data 300 may be stored in a memory of the multifunction peripheral 100. Further, by a scoring result being stored in the electronic scoring data 305, it is possible to easily export the electronic scoring data 305 from the multifunction peripheral 100 to the information device 110. Meanwhile, it is possible to import the electronic scoring data 305 held in the information device 110 into the multifunction peripheral 100. As described above, it is possible to share the data between a plurality of devices, using the electronic scoring data 305.

### <RUI Screen Example (Scoring Execution Screen)>

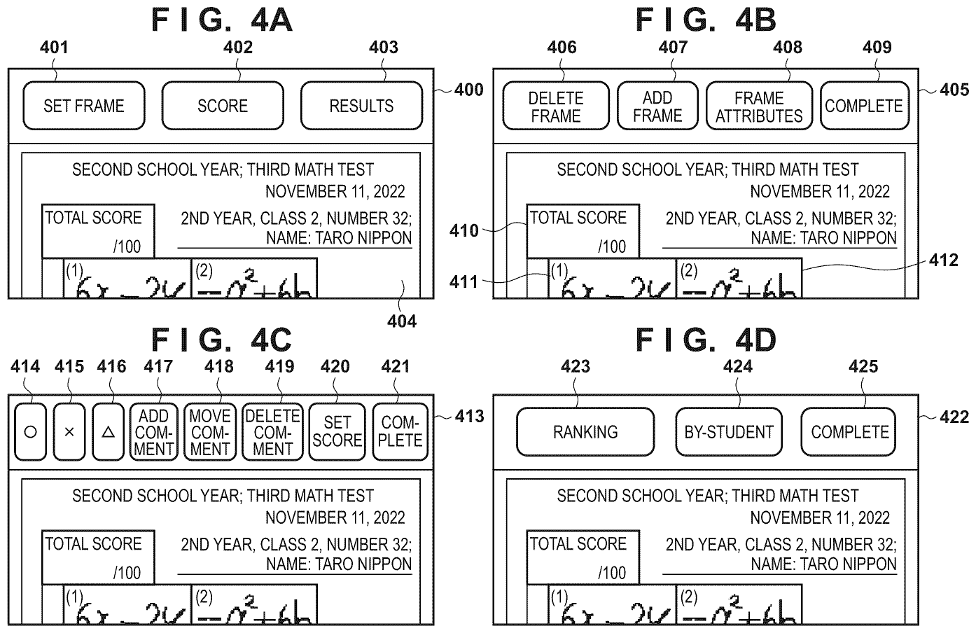

Next, referring to FIGS. 4A-4D, an example of RUI screens (scoring execution screens) of the electronic scoring application according to the present embodiment will be described. Here, screens on which electronic scoring of the electronic scoring application is performed will be described. In the present embodiment, electronic scoring of a test is described as an example, but the present disclosure is not intended to be limited thereto. That is, embodiments of the present disclosure can be applied to a system in which a scanner reads in a filled-in printed material sheet on which predetermined items have been printed, the read image is displayed on a screen and confirmed, a confirmation result is received in response to a user input, and the confirmation result is superimposed on the read image and the result of the superimposing is displayed. The superimposition of the confirmation result on the read image may be performed as a control that embeds an object indicating the confirmation result into the read image. For example, embodiments of the present disclosure can be applied to a system in which, in addition to electronic scoring of a test, a read image obtained by scanning an arbitrary entry sheet such as a business form or an application form is displayed to allow confirmation thereof, and a confirmation result, such as information indicating whether or not an entry is appropriate, is composited with the read image.

A screen 400 is displayed when the electronic scoring html 303 is opened in the browser 112 of the information device 110. When a set frame button 401 is operated, a transition is made to a screen 405 of the electronic scoring application, and a setting of a frame for performing electronic scoring can be performed. When a score button 402 is operated, a transition is made to a screen 413, and electronic scoring can be performed. When a result button 403 is operated, a transition is made to a screen 422, and electronic scoring results can be outputted. A student's answer sheet image 404 is displayed at the lower portion of the page, and scoring content and comments can be confirmed.

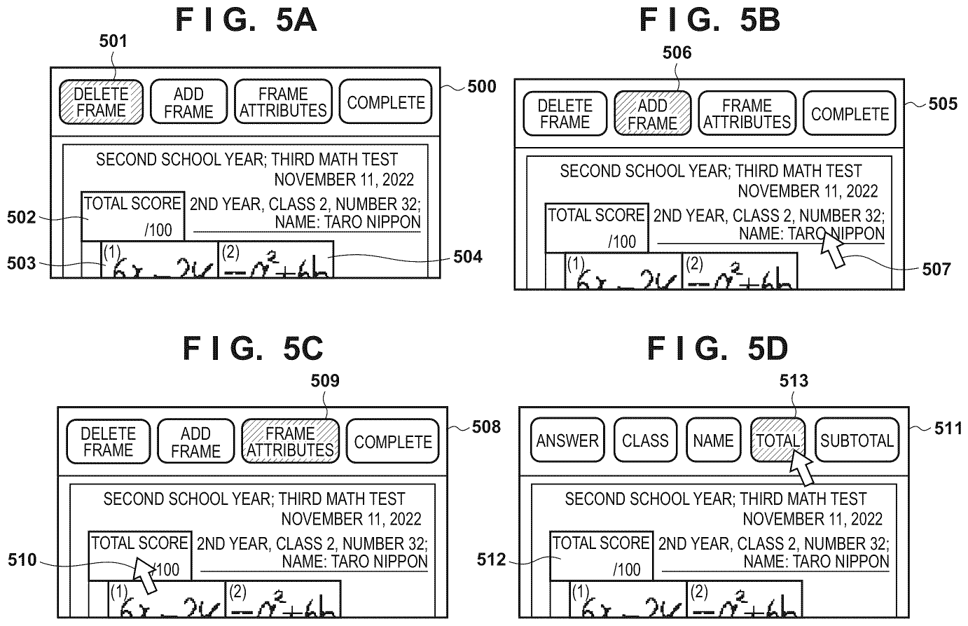

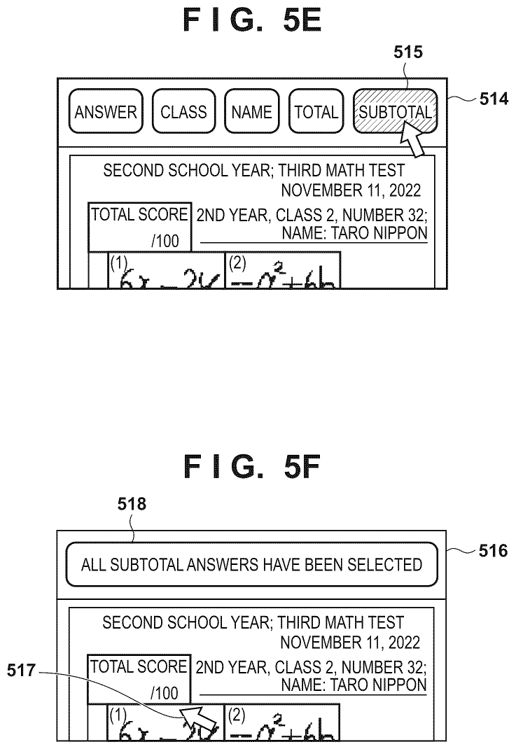

The screen 405 is a screen for setting a frame for designating a region such as an answer field or a subtotal or total field required for performing electronic scoring. Here, the “frame” is an object indicating an outer edge of a predetermined region, and a “frame” is superimposed on the document image 404 and the result of the superimposing is displayed. On the screen 405, a designated frame can be deleted by operating a delete frame button 406. When an add frame button 407 is operated, a new region can be designated and a frame can be added therein. Attributes such as whether the target frame indicates an answer field or a subtotal field can be set by operating a frame attribute button 408. When a complete button 409 is operated, the designated frame information is saved and a transition is made to the screen 400. Further, because operable frames 410 to 412 are displayed on the document image on the screen 405, the user can recognize the processing target frame. The frames 410 to 412 may be displayed to be highlighted by changing a color or causing them to blink. Note that an example of screens for each button operation will be described later with reference to FIGS. 5A-5F.

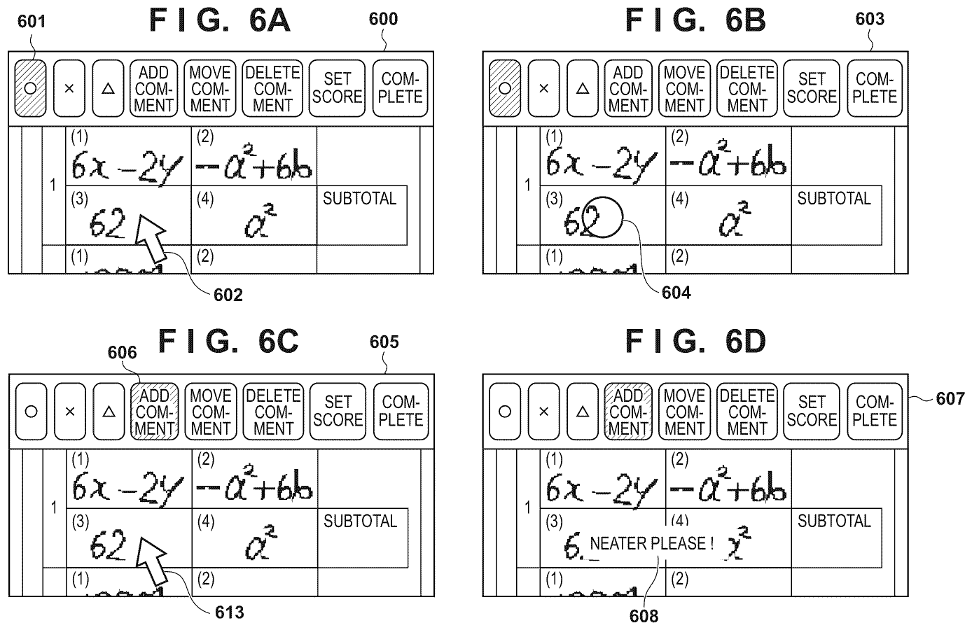

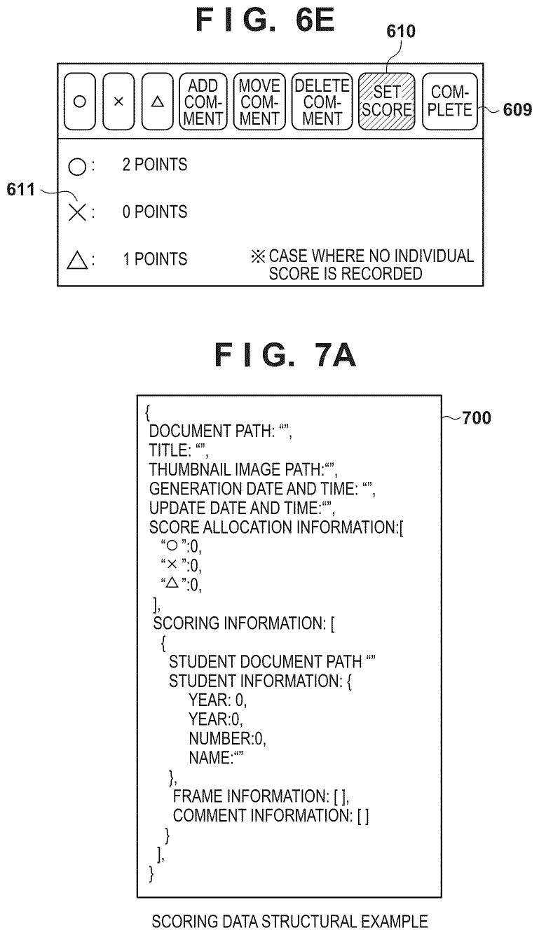

The screen 413 is a screen for performing electronic scoring, such as scoring answers or writing comments. On the screen 413, it is possible to set correct as a scoring result by operating a correct button 414. It is possible to set incorrect as a scoring result by operating an incorrect button 415. It is possible to set partially correct as a scoring result by operating a partially correct button 416. An add comment button 417 can be operated to add a comment. A move comment button 418 can be operated to move the location of a selected comment. A delete comment button 419 can be operated to delete a selected comment. A set score button 420 can be operated to confirm and set correct, incorrect, and partially correct scores in the test. When a complete button 421 is operated, the setting information is saved and a transition is made to the screen 400. Note that an example of screens for each button operation will be described later with reference to FIGS. 6A-6E.

The screen 422 illustrates a screen for outputting results of electronic scoring. When a ranking button 423 is operated, student information sorted in descending order of score can be outputted. When a by-student button 424 is operated, the scoring results for each student can be outputted. When a completion button 425 is operated, a transition is made to the screen 400.

### <RUI Screen Example (Frame Setting Screen)>

Next, referring to FIGS. 5A-5F, an example of RUI screens (frame setting screens) of the electronic scoring application according to the present embodiment will be described. Here, detailed display control of the screen 405 when the set frame button 401 is operated on the screen 400 will be described.

A screen 500 illustrates an example of a screen for deleting frame information. Since a delete frame button 501 has already been selected, it is grayed out. A plurality of selectable frames 502 to 504 are highlighted. When one of the frames 502 to 504 is selected, information related to a frame selected from the electronic scoring data 305 is deleted. A screen 505 illustrates an example of a screen for adding frame information. Since an add frame button 506 has already been selected, it is grayed out. The user can add a frame by operating a pointer 507 displayed in the screen 505. For example, a frame region can be added as frame information to the electronic scoring data 305 by determining the start point of the frame with a click operation or a touch operation, performing a drag operation, and confirming the width, the height, and the end point of the region with a release of the click operation. The pointer 507 can be operated using the operation unit 111 of the information device 110, for example, a touch panel device, a pointing device, or the like.

A screen 508 illustrates an example of a screen for designating a target associated with a target frame as an attribute such as an answer field or a total field. Since a frame attribute button 509 has already been selected, it is grayed out. A user operates a pointer 510 and selects a target frame by a click operation or the like in a state in which the frame attribute button 509 is selected. Here, a situation in which the frame 502 is selected is illustrated. When a frame is selected, a transition is made to a screen 511. The screen 511 illustrates an example of a screen for selecting an attribute to be set for a selected frame. In the screen 511, only a selected frame 512 is highlighted, and various attributes can be selected. For example, in a case where the total field is to be selected as an attribute, a total button 513 need only be operated. By operating the total button 513, an attribute indicating a total field is set for the frame, and then the screen automatically transitions to the screen 508. The set attribute is set in frame information corresponding to the selected frame 512 in the electronic scoring data 305.

A screen 514 illustrates an example of a screen for selecting a subtotal field as an attribute to be set for the selected frame. By operating a subtotal button 515, a subtotal field attribute is set for the frame. Since it is necessary to select a frame to be a subtotal target, the screen transitions to a screen 516 after the button is operated. The screen 516 illustrates an example of a screen for selecting a frame to be a subtotal target. A frame at the position of a pointer 517 can be selected by a click operation or the like. By operating a selected button 518 after selecting all frames, frames to be a subtotal target can be finalized.

### <RUI Screen Example (Correct Setting Screen)>

Next, referring to FIGS. 6A-6E, an example of RUI screens (correct setting screens) of the electronic scoring application according to the present embodiment will be described. Here, detailed display control of the screen 413 when the score button 402 is operated on the screen 400 will be described. Here, “correct setting” refers to a setting of correct for a question in a test.

A screen 600 illustrates an example of a screen for setting correct as a scoring result. Since a correct button 601 has already been selected, it is grayed out. Correct can be set for the frame at the position of a pointer 602 by a click operation or the like. Similar processing is performed when the incorrect button 415 or the partially correct button 416 is operated. The set result is set in corresponding frame information in the electronic scoring data 305. A screen 603 illustrates an example of a screen after correct has been set as a scoring result. An object (for example, a circular object indicating the scoring result) 604 indicating correct is rendered at the center of the frame for which correct has been set. When the incorrect button 415 is operated, an X-shaped object indicating incorrect is assigned, and when the partially correct button 416 is operated, a triangular object indicating partially correct is assigned.

A screen 605 illustrates an example of a screen for adding a comment. Since an add comment button 606 has already been selected, it is grayed out. It is possible to add a comment at the position of a pointer 613 by a click operation or the like. A screen 607 illustrates an example of a screen after the comment addition position has been set. A comment can be input at a designated position 608, and the inputted comment is rendered from the designated position 608. Here, an example in which “neater please!” is rendered as a comment is illustrated. Note that the character string of the comment is also an example of an object indicating the scoring result (confirmation result). The designated position 608 and comment text of the comment are added as comment information in the electronic scoring data 305. Further, when the move comment button 418 is operated and a selected comment is moved, a position of comment information in the electronic scoring data 305 corresponding to the selected comment is updated to a position after the movement has been completed. Then, when the delete comment button 419 is operated and a comment is selected, comment information in the electronic scoring data 305 corresponding to the selected comment is deleted.

A screen 609 illustrates an example of a screen for setting a score allocation for correct, incorrect, and partially correct. Since a set score button 610 has already been selected, it is grayed out. The current score allocation settings 611 for correct, incorrect, and partially correct are displayed, and the score allocation can be confirmed and updated. Here, it indicates that correct is set to 2 points, incorrect is set to 0 points, and partially correct is set to 1 point. Once the score allocation is updated, update information is reflected in information related to the score allocation in the electronic scoring data 305.

### <Data Structure of Scoring Data>

Next, with reference to FIGS. 7A-7B, a data structure of scoring data for holding a result of scoring by electronic scoring according to the present embodiment will be described. Reference numeral 700 denotes a data structure of scoring data for holding a scoring result. Reference numeral 701 denotes specific scoring information held by using the data structure.

The data structure 700 can hold basic information related to the entire test, such as a test name (title), a path of an image, a data generation/update date and time, and score allocation information; scoring information such as a document path for each student; student information; frame information; and comment information for the document. Scoring information 701 indicates a state in which specific information is set for each element of the data structure 700. In the example of the scoring information 701, information about one student is set, but respective information about a plurality of students may be included. In this way, in a case where the electronic scoring is performed, the information of the structure is operated. With such a data structure, it is possible to easily hold a scoring result, and by importing and exporting these pieces of data, it is possible to share electronic scoring data between a plurality of devices.

### <Processing Procedure at the Time of Reading Answer Sheet>

### (Basic Flow)

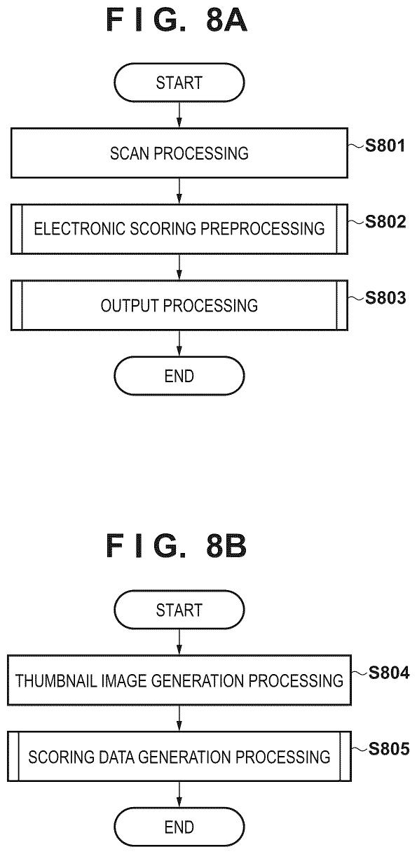

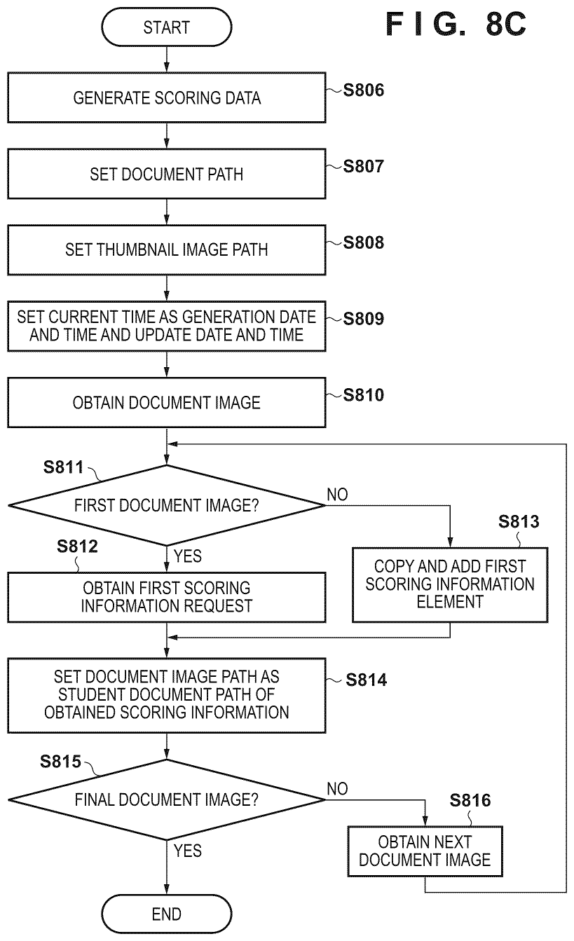

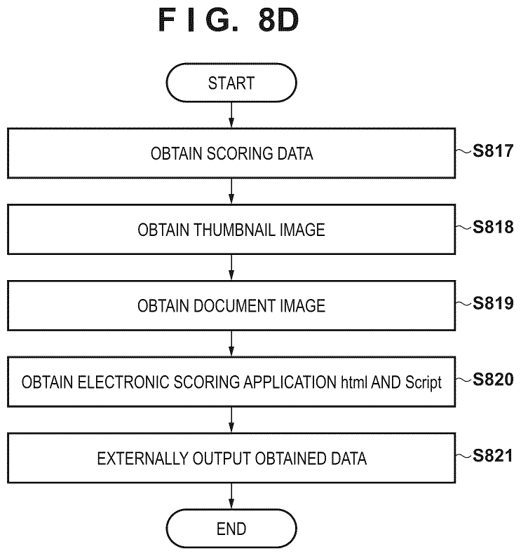

Next, with reference to FIGS. 8A to 8D, a processing procedure for reading an answer sheet on the multifunction peripheral 100 according to the present embodiment will be described. The processing described below is realized by, for example, the CPU 101 reading a program stored in the ROM 102 into the DRAM 103 and executing the program. FIG. 8A illustrates a processing procedure for a basic flow when reading an answer sheet by the multifunction peripheral 100 according to the present embodiment. In this flow, control is performed for a sequence of scan processing and electronic scoring preprocessing for when an answer sheet is read. Here, control executed on the multifunction peripheral 100 while the LUI screens 312 and 314 for the electronic scoring preparation in the electronic scoring application are being displayed will be described. In this flow, control is performed for a sequence of scan processing, electronic scoring preprocessing, and output processing for when an answer sheet is read. Here, the processing is executed in the screens 211 and 212.

In step S801, the CPU 101 receives a scan execution instruction from the user, performs scan processing using the scanner 105, and advances the processing to step S802. The “scan processing” described here is the same as scan processing performed by a general multifunction peripheral 100, and is realized by a known method, and the image is stored in the ROM 102. The above-described scan execution instruction is executed by operating the start button 210 on the screen 209. In step S802, the CPU 101 performs electronic scoring preprocessing, and advances the processing to step S803. Details of preprocessing of the electronic scoring will be described later with reference to FIG. 8B. In step S803, the CPU 101 performs the output processing, and ends the processing of this flowchart. Details of the output processing will be described later since it is a separate flow.

### (Scoring Preprocessing)

FIG. 8B illustrates a detailed procedure of the electronic scoring preprocessing (step S802) performed by the multifunction peripheral 100 according to the present embodiment. In this flow, preprocessing for electronic scoring using the scan image is executed.

In step S804, the CPU 101 generates a thumbnail image for the image read from the ROM 102, and advances the processing to step S805. Here, the generation of a thumbnail image is similar to JPEG or PNG image generation processing performed by a typical multifunction peripheral 100, and is realized by a known method, and the image is stored in the ROM 102. In step S805, the CPU 101 performs scoring data generation processing, and ends the processing of this flowchart. Details of the scoring data generation processing will be described later since it is a separate flow.

### (Scoring Data Generation Processing)

FIG. 8C illustrates a detailed procedure of the scoring data generation processing (step S805) performed by the multifunction peripheral 100 according to the present embodiment. In this flow, processing for generating scoring data and processing for associating the obtained scan image and thumbnail image with scoring data is performed.

In step S806, the CPU 101 reads the scoring data from the ROM 102 and advances the processing to step S807. The scoring data to be read corresponds to the test for which a read instruction has been given on the screen 209. The target scoring data can be specified by using unique information such as the title of the test or the creation date. Configuration may be such that unique identification information such as a UUID is separately generated at the time of analysis of the answer sheet data, and is assigned to the scoring data, which may be used for identification.

In step S807, the CPU 101 sets information indicating a current folder path as the document path of the scoring data, and advances the processing to step S808. In step S808, the CPU 101 sets the name of the thumbnail image stored in the thumbnail image generation processing of above-described step S804 as a scoring data thumbnail image path, and advances the processing to step S809. In step S809, the CPU 101 sets a current date and time as the generation date and time and the update date and time for the scoring data, and advances the processing to step S810.

In step S810, the CPU 101 reads the scan image from the ROM 102 and advances the processing to step S811. In step S811, the CPU 101 determines whether the read scan image is the first scan image. In a case where it is the first scan image, the processing proceeds to step S812, and in a case where it is not the first scan image, the processing proceeds to step S813. In step S812, the CPU 101 obtains the first element included in the scoring information in the scoring data and advances the processing to step S814. Meanwhile, in step S813, the CPU 101 copies the first element included in the scoring information in the scoring data, adds it to the scoring information as a new element, and advances the processing to step S814.

In step S814, the CPU 101 sets the image name of the read scanned image in the ROM 102 to a student document path of the obtained scoring information element and advances the processing to step S815. In step S815, the CPU 101 determines whether the read scan image is the last scan image. If it is the last scan image, the processing of this flowchart is terminated. Meanwhile, if it is not the last scanned image, the processing proceeds to step S816. In step S816, the CPU 101 reads a next scan image from the ROM 102 and returns the processing to step S811.

### (Output Processing)

FIG. 8D illustrates a detailed procedure of the output processing (step S803) performed by the multifunction peripheral 100 according to the present embodiment. In this flow, processing for outputting a series of data generated in the scan processing is performed.

In step S817, the CPU 101 obtains the scoring data generated in the scoring data generation processing of above-described step S805 and advances the processing to step S818. In step S818, the CPU 101 obtains the thumbnail image generated in the thumbnail image generation processing of above-described step S804 and advances the processing to step S819. In step S819, the CPU 101 obtains all answer sheet images generated in the scan processing of above-described step S801 and advances the processing to step S820. In step S820, the CPU 101 obtains electronic scoring html (operation module) and a script (scoring module) from the ROM 102 and advances the processing to step S821. The CPU 101 may obtain the electronic scoring html (operation module) and the script (scoring module) from an external apparatus via a network.

In step S821, the CPU 101 externally outputs all pieces of data obtained in the steps thus far (steps S817 to S820) via the communication unit 107 and ends the processing of this flowchart. An output destination may be an external storage, such as a USB flash memory, or transmission to a network storage (e.g., SMB or FTP), transmission by email, and the like may be performed.

By the above processing (steps S801 to S821), it is possible to externally output the user's local answer sheet images of students, electronic scoring application html and a script, and scoring data collectively. This makes it possible for the user to perform electronic scoring by activating the electronic scoring application html in another device that is the output destination.

### <Drawing Processing (Selection Screen)>

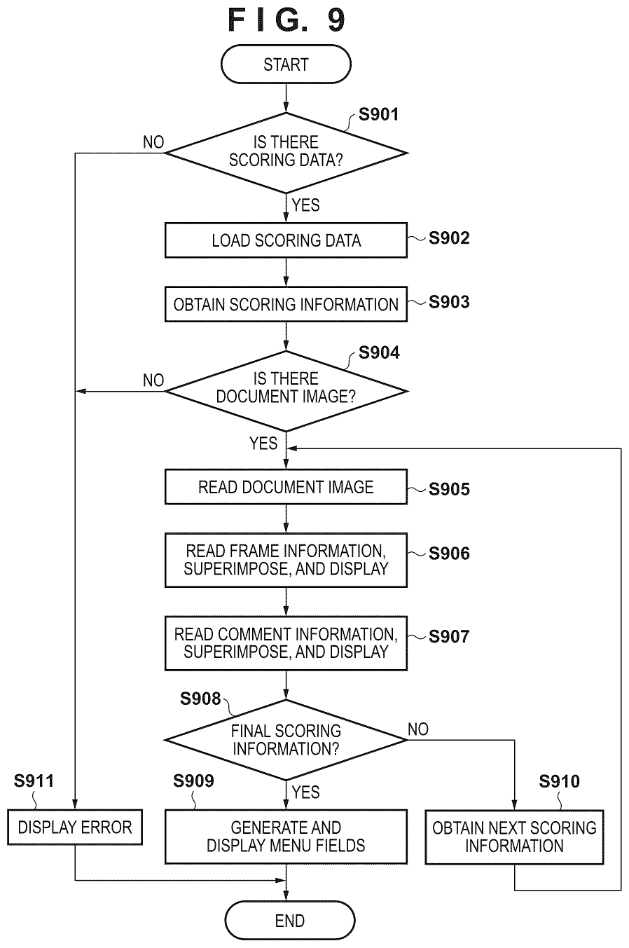

Next, a processing procedure for when a screen of the electronic scoring application according to the present embodiment is drawn will be described with reference to FIG. 9. In this flow, a page for the user to electronically score an answer sheet image is displayed. In the present embodiment, the processing is performed in the screen 400. This flow is executed by the user activating the electronic scoring html 303 outputted from the multifunction peripheral 100 in the user's own information device 110 and thus is executed by the CPU 113 of the information device 110. The processing described below is realized by, for example, the CPU 113 reading a program stored in the ROM 115 and executing the program.

In step S901, the CPU 113 determines whether scoring data is stored in the ROM 115. If there is scoring data, the processing proceeds to step S902. If there is no scoring data, the processing proceeds to step S911. In step S902, the CPU 113 loads the scoring data present in the ROM 115 and advances the processing to step S903.

In step S903, the CPU 113 obtains scoring information from the obtained scoring data and advances the processing to step S904. In step S904, the CPU 113 obtains a document image path from the obtained scoring information and determines whether there is a document image. If there is a document image, the processing proceeds to step S905, and if there is no document image, the processing proceeds to step S911.

In step S905, the CPU 113 reads the document image and advances the processing to step S906. In step S906, the CPU 113 obtains frame information from the scoring information, displays it on the document image in a superimposed manner, and advances the processing to step S907. Regarding a method of performing display in a superimposed manner on a document image, a general known method may be used. For example, there is a method such as that in which a canvas tag is used to draw and display a designated shape (object) in a designated width and height at a position within the frame information on an image displayed using an img tag in html.

In step S907, the CPU 113 obtains comment information from the scoring information, displays it in a superimposed manner on the document image, and advances the processing to step S908. Regarding this superimposition display method, a known method may be used as in step S906. For example, there is a method such as that in which a text tag is used to set a background color to transparent and then designated text is displayed on an image at a position within the comment information.

In step S908, the CPU 113 determines whether the obtained scoring information is the last scoring information element in the scoring data. In a case where it is the last scoring information element, the processing proceeds to step S909, and in a case where it is not the last scoring information element, the processing proceeds to step S910. In step S909, the CPU 113 draws various buttons for performing electronic scoring and ends the processing of this flowchart. Examples of various buttons described here include the buttons 401 to 403 illustrated on the screen 400, for example. Meanwhile, in step S910, the CPU 113 obtains a scoring information element following the currently obtained scoring information element from the scoring data and returns the processing to step S905.

In step S911, the CPU 113 displays a data obtainment error and ends the processing of this flowchart. If scoring data or a document image cannot be obtained, electronic scoring cannot be performed, and so, the error is displayed. With the above processing, it is possible to display various buttons and an image for performing electronic scoring and thereby accept user operations. This makes it possible for the user to perform electronic scoring on their own computer.

As described above, the image processing apparatus according to the present embodiment obtains a scoring module for executing electronic scoring processing and an operation module for displaying screens for electronic scoring and receiving user operations and reads an answer sheet to be electronically scored. Further, the image processing apparatus outputs output data including the read image data, the scoring module, and the operation module. This makes it possible to perform electronic scoring on an answer sheet image to be electronically scored in a local environment on the user's own computer, using the scoring module and the operation module bundled with the image data. Further, the output data includes scoring data, and so, it is possible to hold an electronic scoring result in the scoring data. This makes it possible to hold a partly completed electronic scoring result. The above-described present embodiment is one example of an embodiment of the present disclosure, and when implemented, embodiments of the present disclosure need not be bound to the embodiment described in the present embodiment. Embodiments of the present disclosure may be realized in combination with other embodiments to be described below.

### Second Embodiment

A second embodiment of the present disclosure will be described below. In the above-described first embodiment, a configuration in which data for performing electronic scoring, such as electronic scoring html, an electronic scoring script, and scan data in the multifunction peripheral 100, is externally outputted at the time of scanning has been described. Meanwhile, in the present embodiment, a method of importing and exporting a set of data including image data and scoring data to and from the multifunction peripheral 100 in addition to the configuration of the above-described first embodiment will be described. Description will be omitted for configurations and control similar to those of the above-described first embodiment, and differences from the above-described first embodiment will be mainly described.

### <RUI Screen Example (Scoring Data Processing Screen)>

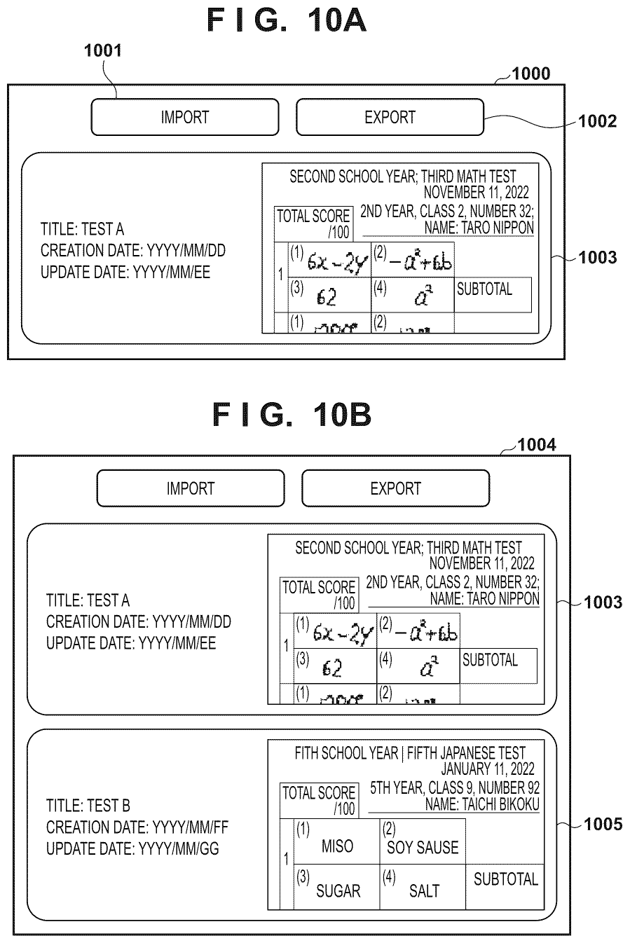

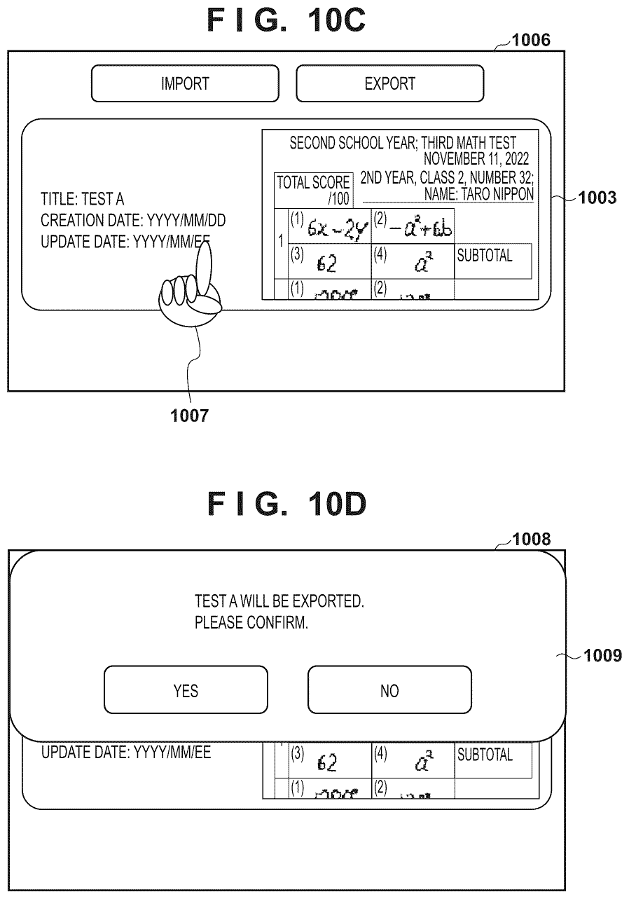

Next, referring to FIGS. 10A-10D, an example of RUI screens (scoring data processing screens) of the electronic scoring application according to the present embodiment will be described. Here, screens for processing scoring data according to the electronic scoring application will be described.

A screen 1000 illustrates an example of a top page to be displayed on an RUI when a connection is made to the multifunction peripheral 100 via the communication unit 107. The screen 1000 is drawn by the electronic scoring application stored in the multifunction peripheral 100. The screen 1000 is configured to include an import button 1001, an export button 1002, and scoring data 1003. By operating the import button 1001, it is possible to register scoring data and an answer sheet image (image data) held by the user in the electronic scoring application in the multifunction peripheral 100. Meanwhile, by operating the export button 1002, it is possible to output scoring data and an answer sheet image registered in the electronic scoring application in the multifunction peripheral 100. For example, it is possible to externally output the test A scoring data 1003 displayed on the screen 1000 from the multifunction peripheral 100.

A screen 1004 illustrates an example of a page after the import button 1001 has been operated on the screen 1000 and scoring data and an answer sheet image has been imported. It can be confirmed that test B scoring data 1005 registered by the user has been added. Meanwhile, a screen 1006 illustrates an example of a page to be displayed when the export button 1002 is operated on the screen 1000. An export target is selected from registered data, and so, the user is asked which test to export. Here, only the test A scoring data 1003 is displayed. By selecting the test A scoring data 1003 to be exported using a pointer 1007, the user can determine a test to be exported.

A screen 1008 is an example of a page to be displayed when target scoring data is selected in the screen 1006. Since there is a possibility that the wrong test may be selected due to an erroneous operation, a confirmation dialog 1009 is displayed and a final confirmation with the user is performed. If “no” is operated in the confirmation dialog 1009, a transition is made to the screen 1000. Meanwhile, if “yes” is operated in the confirmation dialog 1009, scoring data and an answer sheet image of a target test is outputted externally from the multifunction peripheral 100, and then a transition is made to the screen 1000.

### <Processing Related to Scoring Data>

### (Processing for Displaying Screen 1000)

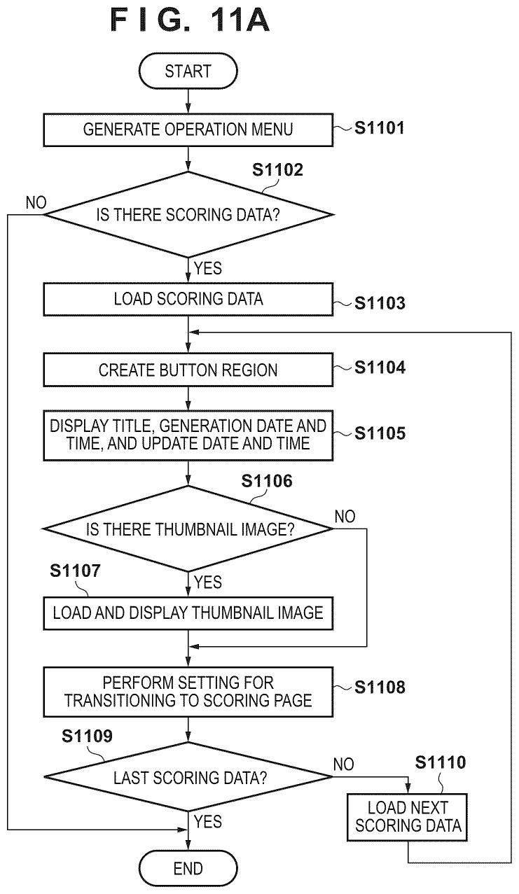

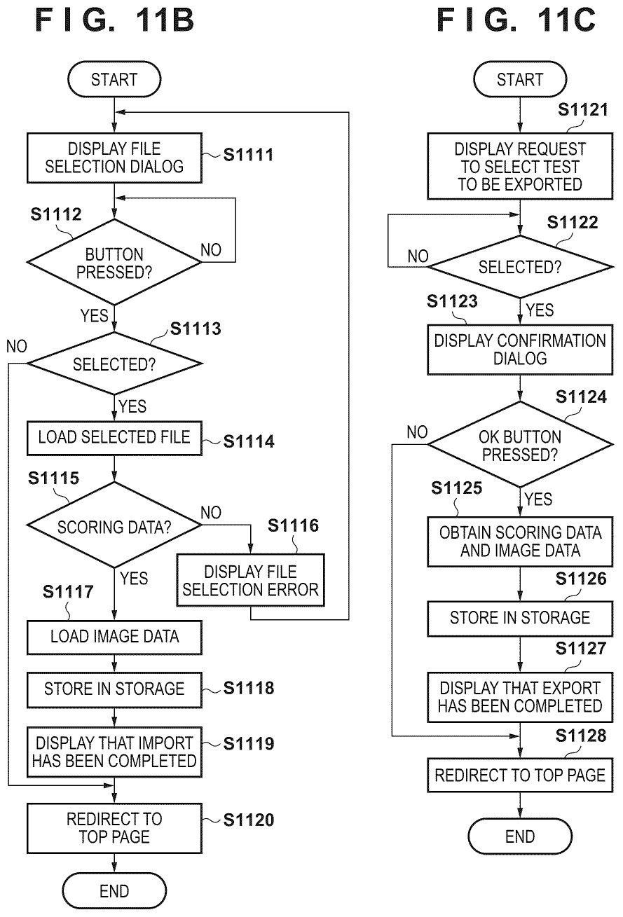

Next, a procedure for processing related to scoring data according to the electronic scoring application according to the present embodiment will be described with reference to FIGS. 11A to 11C. FIG. 11A illustrates a processing sequence at the time of drawing of the screen 1000 for displaying scoring data according to the present embodiment. The processing described below is realized by, for example, the CPU 101 reading a program stored in the ROM 102 and executing the program. In this flow, data to be electronically scored is displayed to the user. Further, a menu for the user to import and export scoring data and an answer sheet image to and from the multifunction peripheral 100 is displayed. In the present embodiment, the processing is performed in the screen 1000.

In step S1101, the CPU 101 generates an operation menu of the screen 1000 and advances the processing to step S1102. The operation menu here indicates, for example, the import button 1001 and the export button 1002 in the screen 1000. In step S1102, the CPU 101 determines whether scoring data is stored in the ROM 102. If scoring data is stored, the processing proceeds to step S1103, and if scoring data is not stored, the processing of this flowchart is terminated.

In step S1103, the CPU 101 reads the scoring data from the ROM 102 and advances the processing to step S1104. If a plurality of pieces of scoring data are held, they are read one at a time and subsequent processing is performed. In step S1104, the CPU 101 generates a button region corresponding to the read scoring data and advances the processing to step S1105. The button region mentioned here, when described more specifically using html as an example, is a button tag. By being set, the tag operates as a button.

In step S1105, the CPU 101 obtains a title, a generation date and time, and an update date and time related to the scoring data from the scoring data, displays them, and advances the processing to step S1106. The display processing mentioned here, when described more specifically using html as an example, is to set corresponding information as display information in the button tag.

In step S1106, the CPU 101 references thumbnail image data in the ROM 102 according to a thumbnail image path in the scoring data and determines whether there is a thumbnail image. If there is a thumbnail image, the processing proceeds to step S1107, and if there is no thumbnail image, the processing proceeds to step S1108. In step S1107, the CPU 101 obtains a path of the thumbnail image from the scoring data, reads the image from the ROM 102, displays it, and advances the processing to step S1108. The display processing mentioned here, when described more specifically using html as an example, is to set an image by setting an img tag in the button tag. In step S1108, the CPU 101 implements a setting for transitioning to a scoring page and advances the processing to step S1109. The transition processing mentioned here, when described more specifically using html as an example, is to set a link to a target page as an onClick attribute of the button tag.

In step S1109, the CPU 101 determines whether the read scoring data is the last scoring data. If it is the last scoring data, the processing of this flowchart is terminated. If it is not the last data, the processing proceeds to step S1110. In step S1110, the CPU 101 reads the next scoring data from the ROM 102 and returns the processing to step S1104. With the above processing, it is possible to display a list of tests to be electronically scored, and further, it is possible to display a menu for performing import and export.

### (Import Processing)

FIG. 11B illustrates a processing procedure at the time of operation of an import button according to the present embodiment. The processing described below is realized by, for example, the CPU 113 reading a program stored in the ROM 115 and executing the program. In this flow, scoring data and an answer sheet image are registered in the multifunction peripheral 100. In the present embodiment, the processing is executed when the import button 1001 is operated on the screen 1000. This flow is performed through the browser 112 of the information device 110 and thus is performed by the CPU 113 of the information device 110.

In step S1111, the CPU 113 displays a file selection dialog and advances the processing to step S1112. Regarding the file selection dialog, a dialog that is a standard feature of an operating system (OS) or the browser 112 need only be displayed. In step S1112, the CPU 113 determines whether a button in the file selection dialog has been operated. If a button has been operated, the processing proceeds to step S1113. If a button has not been operated, the processing proceeds to step S1112 in order to wait for the user to operate a button.

In step S1113, the CPU 113 confirms a type of operation button in the file selection dialog. If a selection button has been operated, the processing proceeds to step S1114, and if a button other than the selection button has been operated, the processing proceeds to step S1120. In a general file selection dialog, two types of buttons, a selection button and a cancel button, are displayed. In step S1114, the CPU 113 loads a selected file and advances the processing to step S1115.

In step S1115, the CPU 113 determines whether the loaded file is scoring data. If it is scoring data, the processing proceeds to step S1117, and if it is not scoring data, the processing proceeds to step S1116. It is possible to determine whether it is scoring data for example, by performing JSON decode on a file and confirming whether there is a property, such as a test name. In step S1116, the CPU 113 displays a file selection error and returns the processing to step S1111.

Meanwhile, in step S1117, the CPU 113 obtains a thumbnail image path and an answer sheet image path stored in the scoring data and loads image data. When loading is completed, the processing proceeds to step S1118. In step S1118, the CPU 113 stores the loaded scoring data, thumbnail image, and answer sheet image in the ROM 102 of the multifunction peripheral 100 and advances the processing to step S1119. In step S1119, the CPU 113 displays that import processing has been completed and advances the processing to step S1120. In step S1120, the CPU 113 transitions to the top page of the electronic scoring application and ends the processing of this flowchart. Since a test has been added by the import processing, the screen 1004 is displayed after the import according to the present embodiment.

With the above processing, it is possible for the user to register scoring data and an answer sheet image held by the information device 110 in the multifunction peripheral 100 by import processing. In the present embodiment, an example in which the CPU 113 of the information device 110 accesses the ROM 102 of the multifunction peripheral 100 through the communication unit 114 of the information device 110 and the communication unit 107 of the multifunction peripheral 100 has been described. However, data may be obtained by a data obtainment command being issued from the communication unit 114 of the information device 110 to the communication unit 107 of the multifunction peripheral 100 via http communication. In such a case, data is obtained by the CPU 101 of the multifunction peripheral 100 accessing the ROM 102, and then is transmitted to the information device 110 through the communication unit 107 via http communication again.

### (Export Processing)

FIG. 11C illustrates a processing procedure at the time of operation of an export button according to the present embodiment. The processing described below is realized by, for example, the CPU 113 reading a program stored in the ROM 115 and executing the program. In this flow, scoring data, an answer sheet image, and a thumbnail image are exported from the multifunction peripheral 100 to the information device 110. In the present embodiment, the processing is executed when the export button 1002 is operated on the screen 1000. Also in this flow, processing is performed through the browser 112 of the information device 110 and thus is performed by the CPU 113 of the information device 110.

In step S1121, the CPU 113 displays a test to be exported so as to be selectable and advances the processing to step S1122. Here, for example, the screen 1006 is displayed. In step S1122, the CPU 113 determines whether a test to be exported has been selected. If it has been selected, the processing proceeds to step S1123, and if it has not been selected, the processing proceeds to step S1122 to wait for the user to make a selection.

In step S1123, the CPU 113 displays a dialog for confirming the test to be exported and advances the processing to step S1124. Here, for example, the screen 1008 is displayed. In step S1124, the CPU 113 determines whether an OK button of the confirmation dialog has been operated. If the OK button has been operated, the processing proceeds to step S1125, and if a button other than the OK button has been operated, the processing proceeds to step S1128.

In step S1125, the CPU 113 obtains scoring data, a thumbnail image, and an answer sheet image of the test to be exported from the ROM 102 of the multifunction peripheral 100 and advances the processing to step S1126. In step S1126, the CPU 113 stores the obtained scoring data, thumbnail image, and answer sheet image in the ROM 115 of the information device 110 and advances the processing to step S1127. In step S1127, the CPU 113 displays that export processing has been completed and advances the processing to step S1128. In step S1128, the CPU 113 transitions to the top page of the electronic scoring application and ends the processing of this flowchart. Here, for example, the screen 1000 is displayed.

With the above processing, it is possible for the user to output scoring data and an answer sheet image held by the multifunction peripheral 100 to the information device 110 by export processing. In the present embodiment, an example in which the CPU 113 of the information device 110 accesses the ROM 102 of the multifunction peripheral 100 through the communication unit 114 of the information device 110 and the communication unit 107 of the multifunction peripheral 100 has been described. However, data may be obtained by a data obtainment command being issued from the communication unit 114 of the information device 110 to the communication unit 107 of the multifunction peripheral 100 via http communication. In such a case, data is obtained by the CPU 101 of the multifunction peripheral 100 accessing the ROM 102, and then is transmitted to the information device 110 through the communication unit 107 via http communication again.

As described above, a set of data including image data and scoring data is outputted from the image processing apparatus to the external apparatus and is obtained from the external apparatus by the image processing apparatus according to user operations according to the present embodiment. It is possible to import and export scoring data and an answer sheet image to and from the information device 110 of the user to the multifunction peripheral 100. The second embodiment described in the present application is only one example, and when implemented, embodiments of the present disclosure need not be bound to the embodiment described in the present embodiment.

### Third Embodiment

A third embodiment of the present disclosure will be described below. In the above-described second embodiment, a configuration in which scoring data can be imported and exported to and from the multifunction peripheral 100 has been described. In the present embodiment, in addition to the above-described second embodiment, merge processing for a case where, when scoring data is imported into the multifunction peripheral 100, its content overlaps with that of existing scoring data will be described. Since the basic configuration is similar to that of the above-described second embodiment, differences from the above-described second embodiment will mainly be described.

### <RUI Screen Example (Scoring Data Processing Screen)>

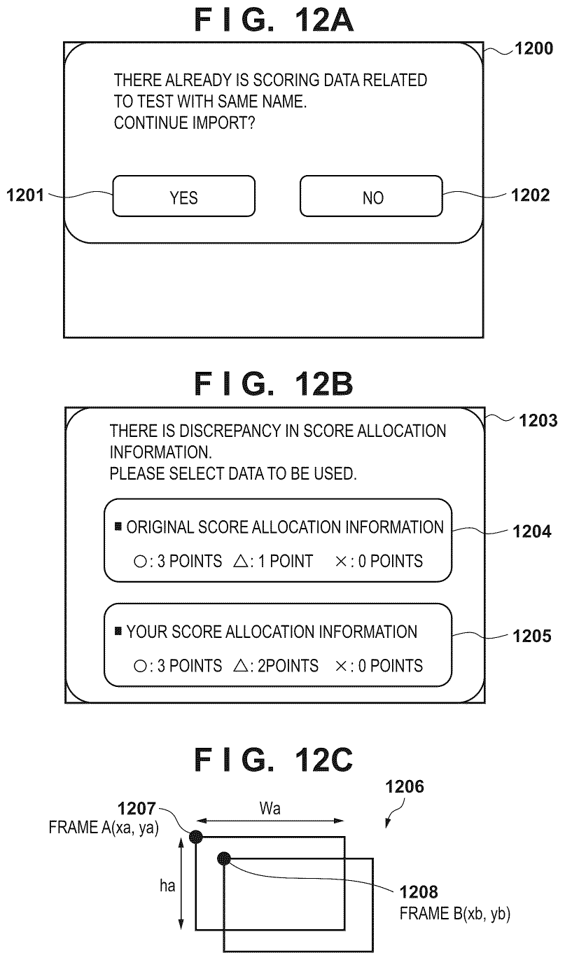

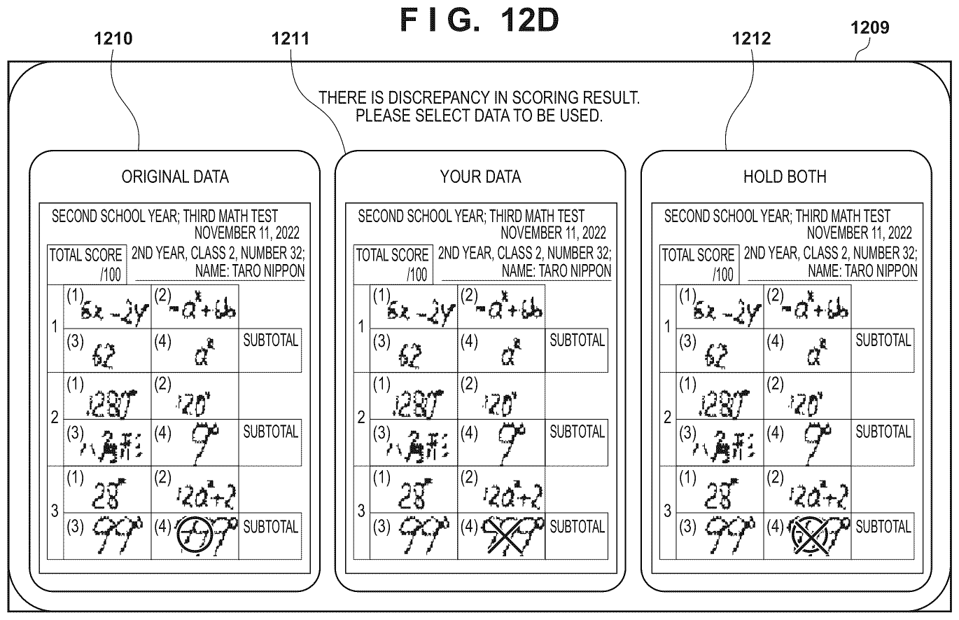

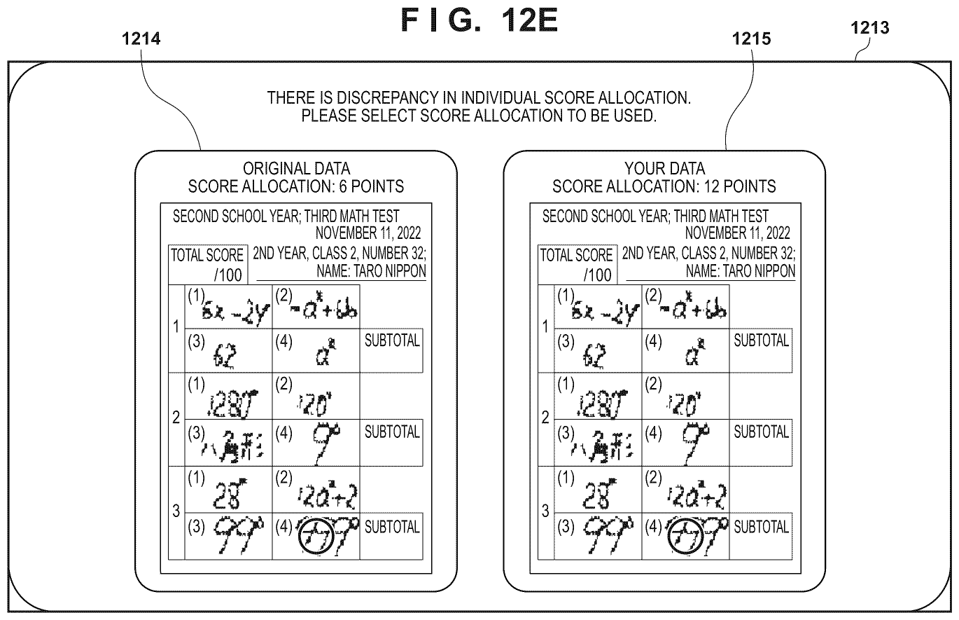

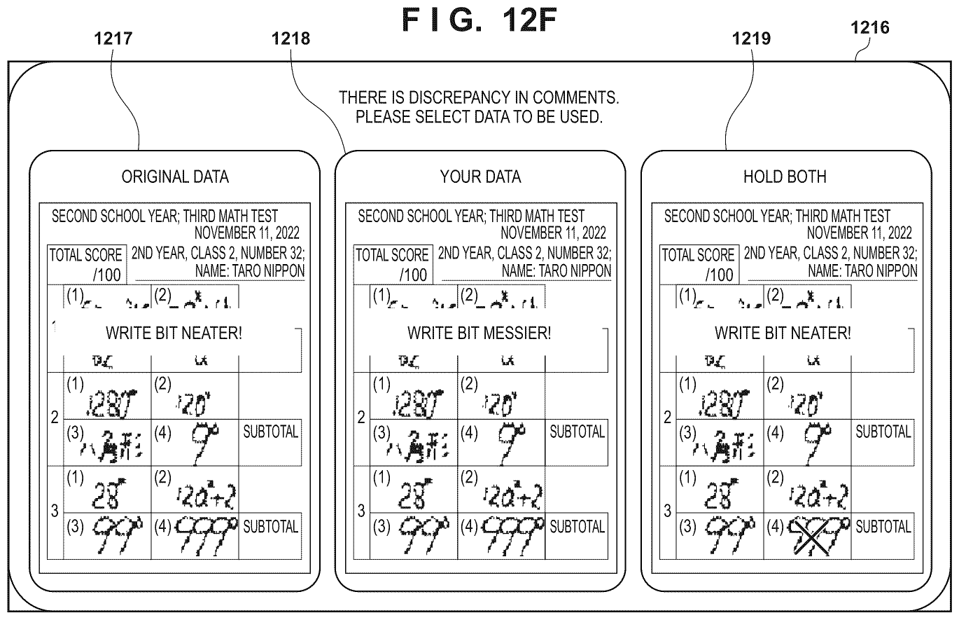

An example of RUI screens (import processing screens) for when importing scoring data according to the present embodiment will be described with reference to FIGS. 12A-12F. A screen 1200 is an example of a screen to be displayed in a case where there is duplicate scoring data (e.g., test with the same name) when the import button 1001 of the screen 1000 is operated. Since the user may unintentionally import a test with the same name, the intention to continue the import is confirmed using this query screen. To continue the import, a yes button 1201 is operated, and to cancel the import, a no button 1202 is operated.

A screen 1203 is an example of a screen to be displayed when there is a difference (discrepancy) in score allocation information of scoring data. The screen 1203 is displayed, for example, when the yes button 1201 is operated on the screen 1200 and there is a difference between original score allocation information and score allocation information to be imported. On the screen 1203, score allocation information recorded in existing scoring data is displayed as original score allocation information 1204, and score allocation information recorded in scoring data to be imported is displayed as your score allocation information 1205. Each piece of score allocation information is configured as a selectable form of an html tag, and it is possible to select score allocation information to be used by selecting any piece of score allocation information.

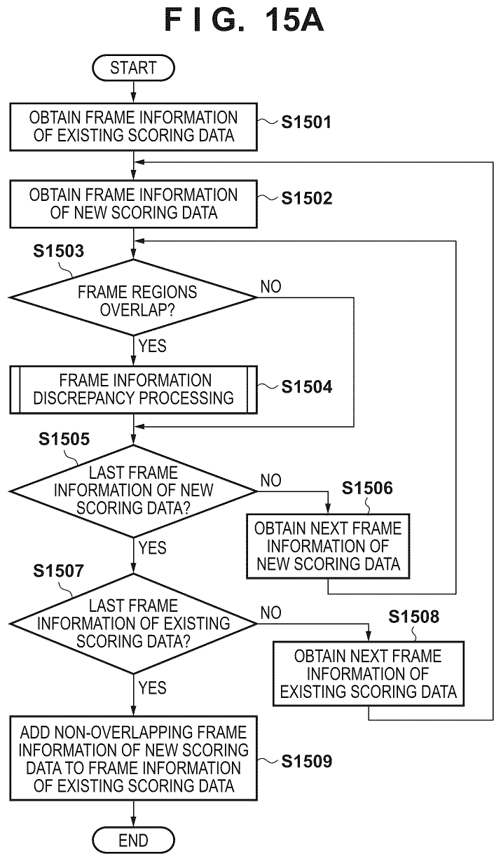

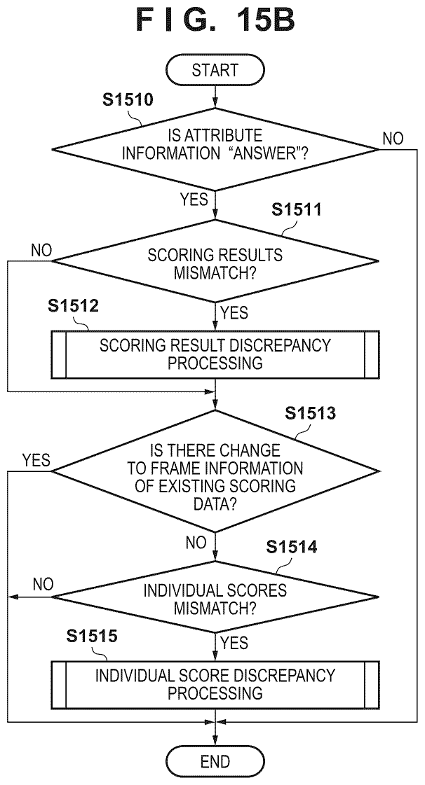

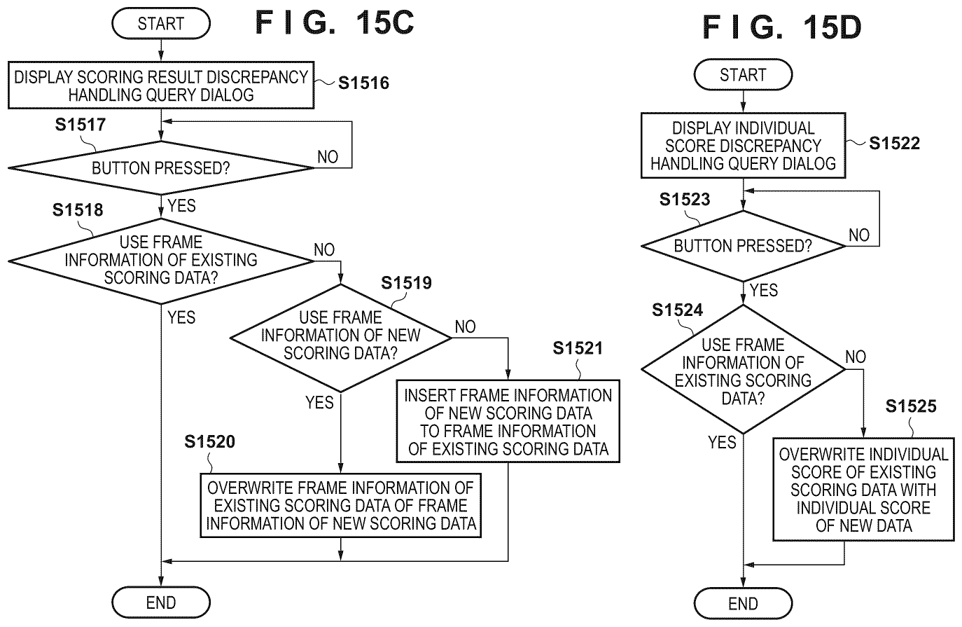

Reference numeral 1206 indicates a state of frames when there is a difference in scoring information. Even if there is a difference in scoring information, if frame regions do not overlap, it is determined that they are scores for different questions and that there is no difference. However, when regions overlap as indicated by reference numeral 1206, they are determined to be merge targets—that is, when a start point (xb, yb) of a region of a frame B (reference numeral 1208) is present in a region (xa, ya) to (xa+wa, ya+ha) of a frame A (reference numeral 1207). Processing will be similarly performed even when an end point rather than the start point of the frame B (reference numeral 1208) overlaps the frame A. Control related to frames will be described later with reference to FIG. 15A.

A screen 1209 illustrates an example of a screen to be displayed when there is a difference in scoring information in a scoring result. On the screen 1209, a button 1210 for selecting that a scoring result recorded in the existing scoring data is original data (correct) is displayed. Further, a button 1211 for selecting that a scoring result recorded in the scoring data to be imported is your (existing) data (incorrect) is displayed. That is, since all indications are configured to be selectable html elements, the user can select a scoring result to be used by operating any of them. Further, since there may be cases where one wishes to defer the determination, a button 1212 for holding both to use either scoring result may be displayed.

A screen 1213 illustrates an example of a screen to be displayed when there is a difference in scoring information in score allocation that the user set individually for each question. A button 1214 for selecting that an individual score allocation recorded in the existing scoring data is original data (6 points) is displayed. Further, a button 1215 for selecting that an individual score allocation recorded in the scoring data to be imported is your data (12 points) is displayed. Since both indications are configured to be selectable html elements, the user can select a scoring result to be used by operating either of them.

A screen 1216 illustrates an example of a screen to be displayed when there is a difference in comment information. A button 1217 for selecting that comment information recorded in the existing scoring data is original data (“write a bit neater!”) is displayed. A button 1218 for selecting that comment information recorded in the scoring data to be imported is your data (“write a bit messier!”) is displayed. Since both indications are configured to be selectable html elements, the user can select comment information to be used by operating either of them. Further, since there may be cases where one wishes to defer the determination, an option 1219 for holding both to use either piece of comment information is displayed. In a case of the option 1219 for holding both, a plurality of different comments may be displayed in a superimposed manner.

### <Import Processing>

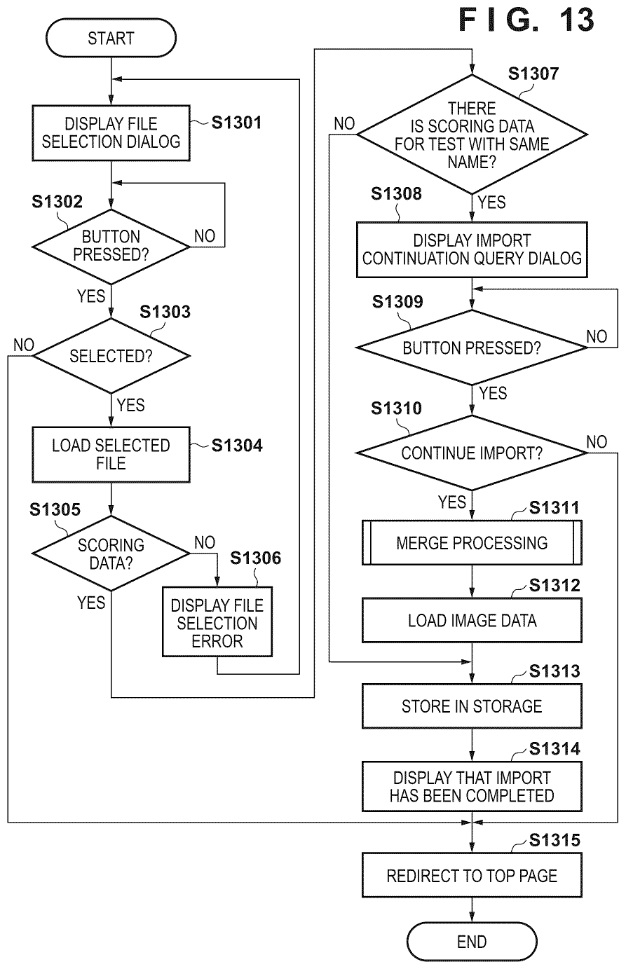

Next, a processing procedure at the time of operation of the import button 1001 of the screen 1000 according to the present embodiment will be described with reference to FIG. 13. By executing this flow, it is possible to execute import continuation query and merge processing for when there is an overlap in scoring data. This processing is performed by the browser 112 of the information device 110 and thus is performed by the CPU 113 of the information device 110. The processing described below is realized by, for example, the CPU 113 reading a program stored in the ROM 115 and executing the program.

In step S1301, the CPU 113 displays a file selection dialog and advances the processing to step S1302. Regarding the file selection dialog, a dialog that is a standard feature of an operating system (OS) or the browser 112 need only be displayed. In step S1302, the CPU 113 determines whether a button in the file selection dialog has been operated. If a button has been operated, the processing proceeds to step S1303, and if a button has not been operated, the processing of step S1302 is executed periodically to wait for the user to operate a button.

In step S1303, the CPU 113 confirms a type of operation button in the file selection dialog. If a selection button has been operated, the processing proceeds to step S1304, and if a button other than the selection button has been operated, the processing proceeds to step S1315. In a general file selection dialog, two types of buttons, a selection button and a cancel button, are displayed. In step S1304, the CPU 113 loads a selected file and advances the processing to step S1305. In step S1305, the CPU 113 determines whether the loaded file is scoring data. If it is scoring data, the processing proceeds to step S1307, and if it is not scoring data, the processing proceeds to step S1306. It is possible to determine whether it is scoring data for example, by performing JSON decode on a file and confirming whether there is a property, such as a test name. In step S1306, the CPU 113 displays a file selection error and returns the processing to step S1301.

In step S1307, the CPU 113 determines whether there is scoring data having the same test name in the ROM 102 of the multifunction peripheral 100. If there is scoring data with the same test name, the processing proceeds to step S1308, and if there is no scoring data with the same test name, the processing proceeds to step S1313. In step S1308, the CPU 113 displays an import continuation query dialog and advances the processing to step S1309. In the present embodiment, the screen 1200 is displayed.

In step S1309, the CPU 113 determines whether a button in the import continuation query dialog has been operated. If a button has been operated, the processing proceeds to step S1310 to confirm whether to continue the import, and if a button has not been operated, the processing proceeds to step S1309 to wait for the user to operate a button. In step S1310, the CPU 113 confirms a type of button that has been operated. If a button indicating continuation of the import processing has been operated, the processing proceeds to step S1311, and if a button indicating cancellation of the import processing has been operated, the processing proceeds to step S1315.

In step S1311, the CPU 113 performs merge processing and advances the processing to step S1312. Details of the merge processing will be described later. In step S1312, the CPU 113 obtains paths of a thumbnail image and an answer sheet image from the scoring data, loads the images, and advances the processing to step S1313. In step S1313, the CPU 113 stores the scoring data for which the merge processing has been completed, the thumbnail image, and the answer sheet image in the ROM 102 of the multifunction peripheral 100 and advances the processing to step S1314. In step S1314, the CPU 113 displays that the import has been completed and advances the processing to step S1315. In step S1315, the CPU 113 causes a transition to the screen 1000 and ends the processing of this flowchart.

### <Merge Processing>

### (Basic Flow)

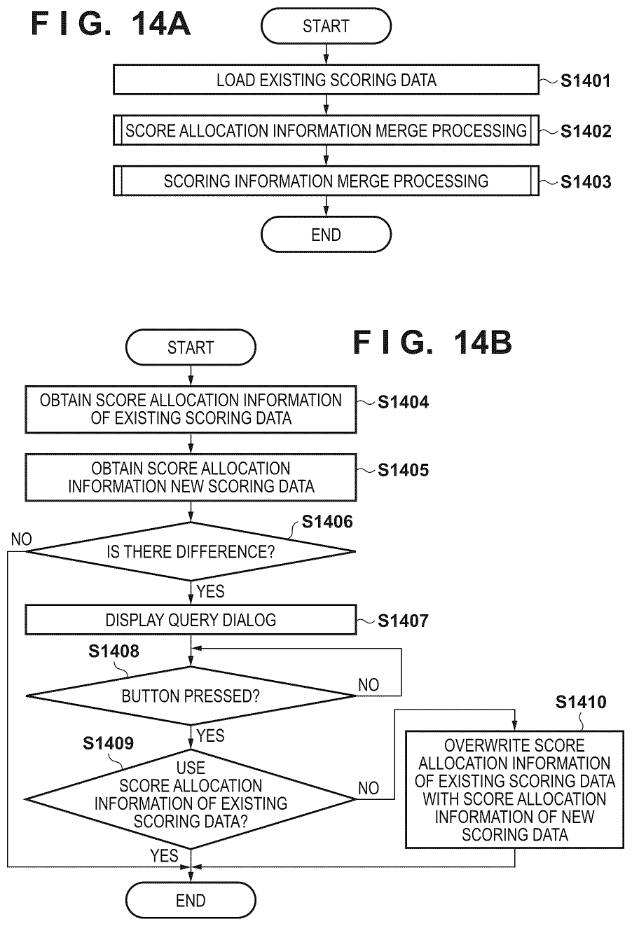

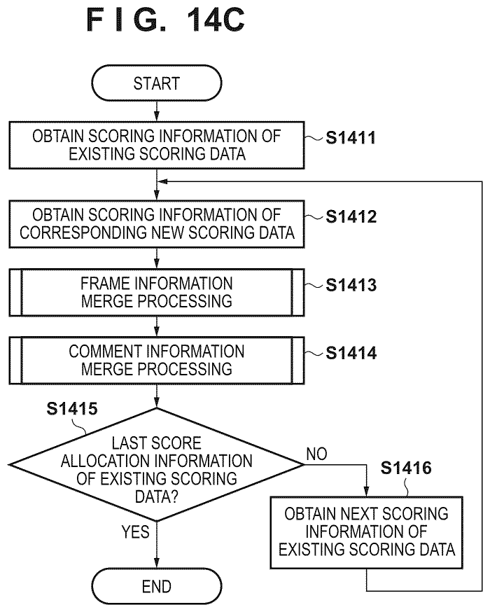

Next, details of the processing of above-described step S1311 will be described with reference to FIGS. 14A to 16B. FIG. 14A illustrates a basic flow of the merge processing. This flow makes it possible to perform merge processing for when there is a difference between existing scoring data and scoring data to be imported.

In step S1401, the CPU 113 loads existing scoring data from the ROM 102 of the multifunction peripheral 100 and advances the processing to step S1402. In step S1402, the CPU 113 performs score allocation information merge processing and advances the processing to step S1403. Details of the score allocation information merge processing will be described later. In step S1403, the CPU 113 performs scoring information merge processing and ends the processing of this flowchart. Details of the scoring information merge processing will be described later.

### (Merging of Score Allocation Information)

FIG. 14B illustrates a detailed processing procedure of the score allocation information merge processing (step S1402). In this flow, merge processing for when there is a difference in score allocation information between existing scoring data and scoring data to be imported is performed.

In step S1404, the CPU 113 obtains score allocation information of existing scoring data and advances the processing to step S1405. In step S1405, the CPU 113 obtains score allocation information of scoring data to be imported and advances the processing to step S1406. In step S1406, the CPU 113 compares the two pieces of obtained score allocation information and determines whether there is a difference. If there is a difference, the processing proceeds to step S1407, and if there is no difference, the processing of this flowchart is terminated.

In step S1407, the CPU 113 displays a score allocation information difference query dialog and advances the processing to step S1408. In the present embodiment, the screen 1203 is displayed. In step S1408, the CPU 113 determines whether a button in the score allocation information difference query dialog has been operated. If a button has been operated, the processing proceeds to step S1409, and if a button has not been operated, the processing proceeds to step S1408 to wait for the user to operate a button.

In step S1409, the CPU 113 determines whether a button for using the score allocation information of the existing scoring data has been selected. In the case of using the score allocation information of the existing scoring data, the processing of this flowchart is terminated. In the case of using the score allocation information of the scoring data to be imported, the processing proceeds to step S1410. In step S1410, the CPU 113 overwrites the score allocation information of the existing scoring data with the score allocation information of the scoring data to be imported and ends the processing of this flowchart.

### (Merging of Scoring Information)

FIG. 14C illustrates a detailed processing procedure of the scoring information merge processing (step S1403). In this flow, merge processing for when there is a difference in scoring information between existing scoring data and scoring data to be imported is performed.

In step S1411, the CPU 113 obtains scoring information of existing scoring data from the ROM 102 of the multifunction peripheral 100 and advances the processing to step S1412. In step S1412, the CPU 113 obtains scoring information of scoring data to be imported corresponding to the scoring information obtained in step S1411 and advances the processing to step S1413. That is, it means that since scoring data stores scoring information for a plurality of students, scoring information corresponding to scoring information of a particular student obtained from the existing scoring data is obtained from the scoring data to be imported. Since student information of scoring information stores information identifying an individual student, it is possible to obtain corresponding scoring information by comparing the student information.

In step S1413, the CPU 113 performs frame information merge processing and advances the processing to step S1414. Details of the frame information merge processing will be described later. In step S1414, the CPU 113 performs comment information merge processing and advances the processing to step S1415. Details of the comment information merge processing will be described later.

In step S1415, the CPU 113 determines whether the currently-referenced scoring information is the last scoring information element in the existing scoring data. If it is the last scoring information element, the processing of this flowchart is terminated. If it is not the last scoring information element, the processing proceeds to step S1416. In step S1416, the CPU 113 obtains a scoring information element following the currently-referenced scoring information element of the existing scoring data and returns the processing to step S1412.

### (Merging of Frame Information)

FIG. 15A illustrates a detailed processing procedure of the frame information merge processing (step S1413). In this flow, processing for merging frame information in existing scoring data and scoring data to be imported is performed.

In step S1501, the CPU 113 obtains frame information of existing scoring data from the ROM 102 of the multifunction peripheral 100 and advances the processing to step S1502. In step S1502, the CPU 113 obtains frame information of scoring data to be imported and advances the processing to step S1503. In step S1503, the CPU 113 determines whether regions of the two pieces of frame information overlap. Regarding determination as to whether regions overlap, a method described in a frame state (reference numeral 1206) at the time there is a difference in scoring information may be used. If frame regions overlap, the processing proceeds to step S1504, and if frame regions do not overlap, the processing proceeds to step S1505.

In step S1504, the CPU 113 performs frame information differential processing and advances the processing to step S1505. Details of the frame information differential processing will be described later. In step S1505, the CPU 113 determines whether the currently-referenced frame information element of the scoring data to be imported is the last element. If it is the last element, the processing proceeds to step S1507, and if it is not the last element, the processing proceeds to step S1506. This step is necessary to determine whether a region of one piece of frame information in the existing scoring data overlaps with that of any of the frame information in the scoring data to be imported.

In step S1506, the CPU 113 obtains an element following the currently-referenced frame information element of the scoring data to be imported and advances the processing to step S1503. In step S1507, the CPU 113 determines whether the currently-referenced frame information element of the existing scoring data is the last element. If it is the last element, the processing proceeds to step S1509, and if it is not the last element, the processing proceeds to step S1508. This step is necessary to determine whether any region of the frame information in the existing scoring data overlaps with that of any of the frame information in the scoring data to be imported.

In step S1508, the CPU 113 obtains an element following the currently-referenced frame information element of the existing scoring data and advances the processing to step S1502. In step S1509, the CPU 113 adds non-overlapping frame information in the frame information of the scoring data to be imported to the frame information of the existing scoring data and ends the processing of this flowchart.

### (Frame Information Differential Processing)

FIG. 15B illustrates a detailed processing procedure of the frame information differential processing (step S1504). In this flow, merge processing for when there is a difference in frame information between existing scoring data and scoring data to be imported is performed.

In step S1510, the CPU 113 determines whether an attribute of frame information in which there is a difference is an answer attribute. If it is an answer attribute, the processing proceeds to step S1511, and if it is not an answer attribute, the processing of this flowchart is terminated. Here, attributes that can be set are answer, class, name, total, and subtotal, and since frames other than those for answers rarely overlap, the attributes are narrowed down to the answer attribute. A configuration may be taken so as not to limit the processing only to the answer attribute and may perform the processing for all attributes.

In step S1511, the CPU 113 determines whether scoring results in two pieces of frame information mismatch. If they mismatch, the processing proceeds to step S1512, and if they do not mismatch, the processing proceeds to step S1513. The scoring results described here indicate the scoring results (correct, incorrect, and partially correct) described in the description of the screen 413. In step S1512, the CPU 113 performs scoring result differential processing and advances the processing to step S1513. Details of the scoring result differential processing will be described later.

In step S1513, the CPU 113 determines whether there has been a change to the frame information of the existing scoring data. If there has been no change, the processing proceeds to step S1514, and if there has been a change, the processing of this flowchart is terminated. That is, if the scoring result differential processing (step S1512) has been performed, the frame information will have been updated, and so, there is no need to perform subsequent processing. In step S1514, the CPU 113 determines whether individual scores in two pieces of frame information do not match. If they do not match, the processing proceeds to step S1515, and if they are not a mismatch, the processing of this flowchart is terminated. In step S1515, the CPU 113 performs individual score differential processing and ends the processing of this flowchart. Details of the individual score differential processing will be described later.

### (Scoring Result Differential Processing)

FIG. 15C illustrates a detailed processing procedure of the scoring result differential processing (step S1512). In this flow, merge processing for when there is a difference between scoring results in frame information of existing scoring data and scoring data to be imported is performed.

In step S1516, the CPU 113 displays the screen 1209 indicating a difference between scoring results and advances the processing to step S1517. In step S1517, the CPU 113 determines whether a button displayed on the screen 1209 has been operated. If a button has been operated, the processing proceeds to step S1518, and if a button has not been operated, the processing proceeds to step S1517 to wait for the user to operate a button. In the present embodiment, either the button 1210 for selecting the original data displayed on the screen 1209, the button 1211 for selecting the existing data, or the button 1212 for selecting to hold both is operated.

In step S1518, the CPU 113 determines whether a button indicating to use frame information of the existing scoring data has been operated on the screen 1209. If that button has been operated, the processing of this flowchart is terminated, and if that button has not been operated, the processing proceeds to step S1519. In the present embodiment, it is determined whether the button 1210 for selecting the original data has been operated.

In step S1519, the CPU 113 determines whether a button indicating to use frame information of the scoring data to be imported has been operated on the screen 1209. If that button has been operated, the processing proceeds to step S1520, and if a button other than that button has been operated, the processing proceeds to step S1521. In the present embodiment, it is determined whether the button 1211 for selecting the existing data has been operated.

In step S1520, the CPU 113 overwrites the frame information of the existing scoring data with the frame information of the scoring data to be imported and ends the processing of this flowchart. With this, the frame information is replaced, and it is possible to use frame information of scoring data that the user is importing. Meanwhile, in step S1521, the CPU 113 inserts the frame information of the scoring data to be imported into the frame information of the existing scoring data and ends the processing of this flowchart. With this, the frame information of the scoring data the user is importing is added, and so, it is possible to hold both pieces of frame information.

### (Individual Score Differential Processing)

FIG. 15D illustrates a detailed processing procedure of the individual score differential processing (step S1515). In this flow, merge processing for when there is a difference between individual scores in frame information of existing scoring data and scoring data to be imported is performed. The individual scores indicate scores that are set when the user designates scores individually for each piece of frame information. It is necessary information since, in typical tests, there is weighted score allocation.

In step S1522, the CPU 113 displays the screen 1213 and advances the processing to step S1523. In step S1523, the CPU 113 determines whether a button has been operated on the screen 1213. If a button has been operated, the processing proceeds to step S1524, and if a button has not been operated, the determination of step S1523 is performed periodically to wait for the user to operate a button.

In step S1524, the CPU 113 determines whether a button indicating to use an individual score of the existing scoring data has been operated on the screen 1213. If that button has been operated, the processing of this flowchart is terminated, and if a button other than that button has been operated, the processing proceeds to step S1525. In the present embodiment, it is determined whether the button 1214 for selecting the original data has been operated. In step S1525, the CPU 113 overwrites the individual score of the existing scoring data with the individual score of the scoring data to be imported and ends the processing of this flowchart. This makes it possible for to use the individual score of the scoring data that the user is importing.

### (Merging of Comment Information)

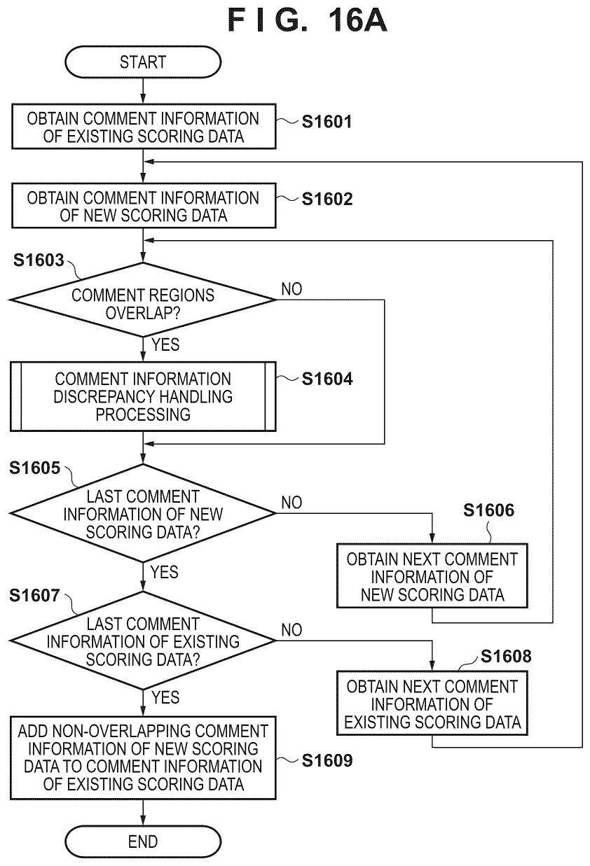

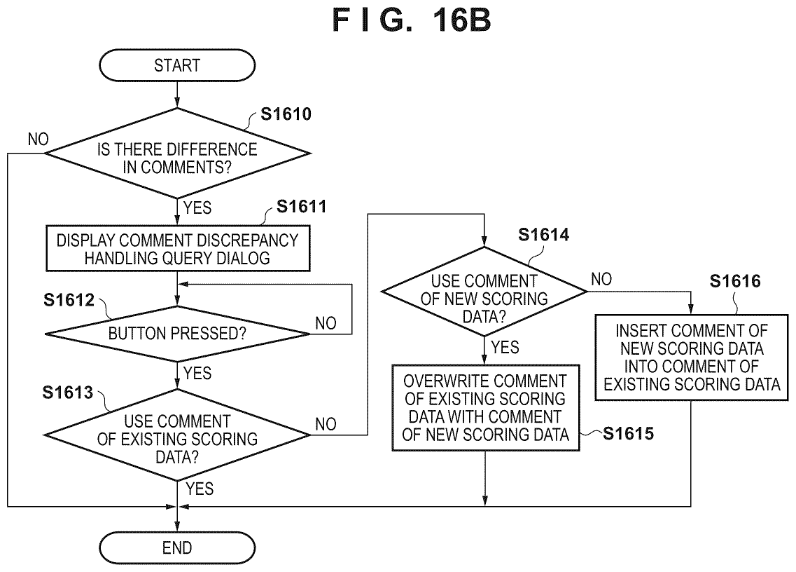

FIG. 16A illustrates a processing procedure of the comment information merge processing (step S1414). In this flow, merge processing for when there is a difference in comment information between existing scoring data and scoring data to be imported is performed.

In step S1601, the CPU 113 obtains comment information of existing scoring data and advances the processing to step S1602. In step S1602, the CPU 113 obtains comment information of scoring data to be imported and advances the processing to step S1603. In step S1603, the CPU 113 determines whether regions of the comments obtained in steps S1601 and S1602 overlap. If comment regions overlap, the processing proceeds to step S1604, and if comment regions do not overlap, the processing proceeds to step S1605. It is possible to confirm the overlap of comment regions using a method similar to that for a frame state (reference numeral 1206) at the time there is a difference in scoring information. Since comment drawing position and comment text are stored in comment information, a region size is calculated from the drawing position and a text length, and overlap is confirmed.

In step S1604, the CPU 113 performs comment information difference handling processing and advances the processing to step S1605. Details of the comment information difference handling processing will be described later since it is a separate flow. In step S1605, the CPU 113 determines whether the currently-referenced comment information element of the scoring data to be imported is the last element. If it is the last element, the processing proceeds to step S1607, and if it is not the last element, the processing proceeds to step S1606.

In step S1606, the CPU 113 obtains an element following the currently-referenced comment information element of the scoring data to be imported and returns the processing to step S1603. This makes it possible to confirm an overlap of regions for a comment information element of the existing scoring data and any comment information elements of the scoring data to be imported. In step S1607, the CPU 113 determines whether the currently-referenced comment information element of the existing scoring data is the last element. If it is the last element, the processing proceeds to step S1609, and if it is not the last element, the processing proceeds to step S1608.

In step S1608, the CPU 113 obtains an element following the currently-referenced comment information element of the existing scoring data and advances the processing to step S1602. This makes it possible to confirm an overlap of regions for any comment information element of the existing scoring data and any comment information elements of the scoring data to be imported. Meanwhile, in step S1609, the CPU 113 adds a non-overlapping comment information element of the scoring data to be imported to the comment information of the existing scoring data and ends the processing of this flowchart.

### (Comment Information Differential Processing)

FIG. 16B illustrates a processing procedure of the comment information difference handling processing (step S1604). In this flow, merge processing for when there is a difference in content of comment information between existing scoring data and scoring data to be imported is performed.

In step S1610, the CPU 113 confirms whether there is a difference in content of comment text. Regarding the difference, it is determined whether there is a difference in character strings between them. If there is a difference, the processing proceeds to step S1611, and if there is no difference, the processing of this flowchart is terminated. In step S1611, the CPU 113 displays the screen 1216 and advances the processing to step S1612.

In step S1612, the CPU 113 determines whether a button has been operated on the screen 1216. If a button has been operated, the processing proceeds to step S1613, and if a button has not been operated, the determination of step S1612 is performed periodically to wait for the user to operate a button. In step S1613, the CPU 113 determines whether the button 1217 indicating to use comment information of the existing scoring data has been operated. If the button 1217 has been operated, the processing of this flowchart is terminated, and if a button other than the button 1217 has been operated, the processing proceeds to step S1614.

In step S1614, the CPU 113 determines whether the button 1218 for selecting your data has been operated. If that button has been operated, the processing proceeds to step S1615, and if a button other than that button has been operated, the processing proceeds to step S1616. In step S1615, the CPU 113 overwrites the comment information element of the existing scoring data with the comment information element of the scoring data to be imported and ends the processing of this flowchart. This makes it possible to use comment information of the scoring data to be imported. Meanwhile, in step S1616, the CPU 113 adds the comment information element of the scoring data to be imported to the comment information of the existing scoring data and ends the processing of this flowchart. This makes it possible to add comment information elements of the scoring data to be imported while retaining comment information elements of the existing scoring data.

As described above, when importing a set of data including image data and scoring data from an external apparatus, if there is an overlap with already-held data, the image processing apparatus according to the present embodiment queries as whether to continue the import according to a user operation. Further, when importing overlapping data, the image processing apparatus respectively merges each item of scoring data. Regarding the merge, which data to prioritize and perform merging may be determined for each item according to a user operation. This makes it possible to, when image data and an answer sheet of scoring data are imported from the user's information device 110 into the multifunction peripheral 100, if there is an overlap in content with existing data held in the multifunction peripheral 100, appropriately resolve the overlap. Therefore, according to the present embodiment, when executing electronic scoring, it is possible to appropriately share a scoring result among a plurality of devices. The third embodiment described in the present application is only one example, and when implemented, embodiments of the present disclosure need not be bound to the embodiment described in the present embodiment.

### Fourth Embodiment

A fourth embodiment of the present disclosure will be described below. In the present embodiment, in addition to the above-described third embodiment, a configuration in which only the electronic scoring module 302 for performing the electronic scoring processing and the electronic scoring html 303 for displaying screens for electronic scoring and receiving user operations are outputted from the multifunction peripheral 100 will be described. Further, control for registering data related to a test to be electrically scored in the outputted electronic scoring module 302 and the electronic scoring html 303 will be described.

### <Screen Related to Export>

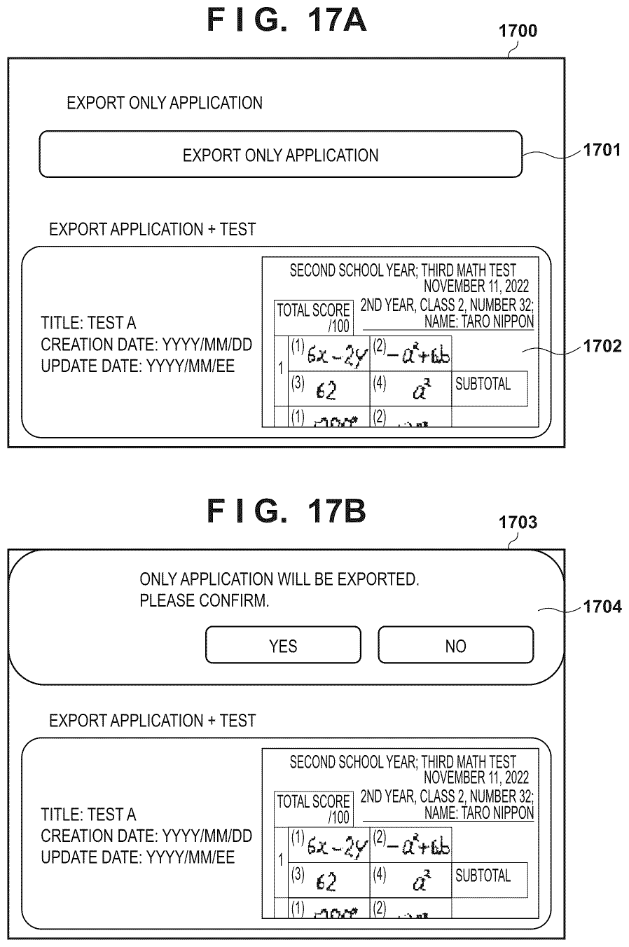

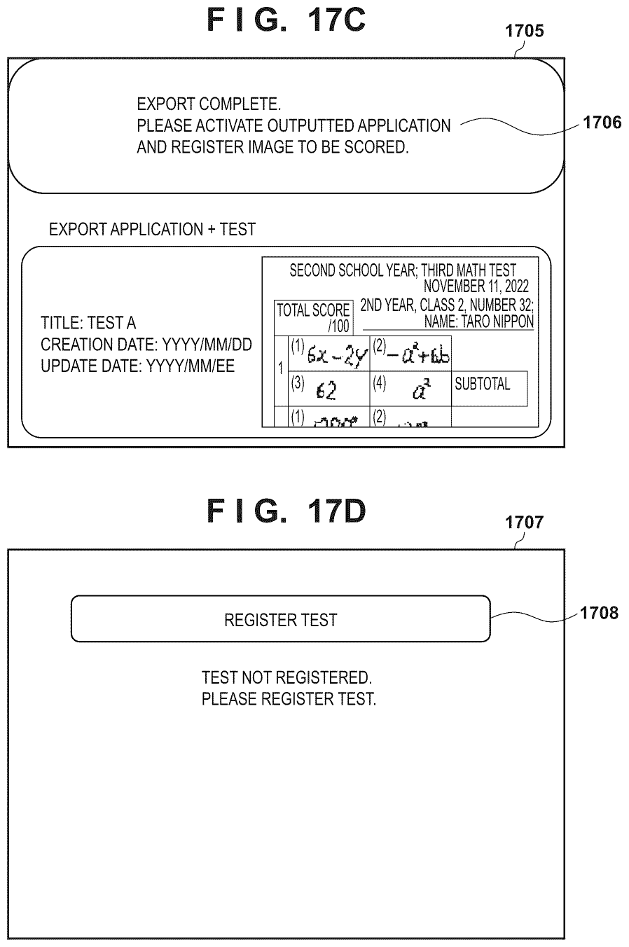

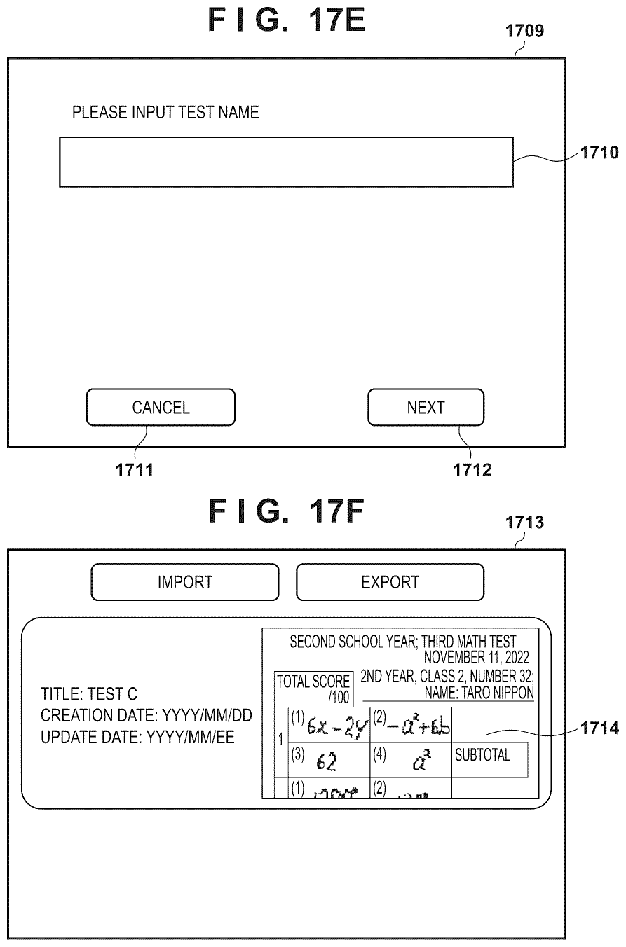

An example of RUI screens (export processing screens) for when exporting scoring data according to the present embodiment will be described with reference to FIGS. 17A-17F. A screen 1700 illustrates an example of a screen to be displayed when the export button 1002 of the screen 1000 is operated. On the screen 1700, a button 1701, which is for exporting only the application and is for outputting only the electronic scoring module 302 and the electronic scoring html 303, and a button 1702 for outputting scoring data and an answer sheet image related to a test are displayed.

A screen 1703 illustrates an example of a screen to be displayed when the button 1701 for exporting only the application is operated. A dialog 1704 is displayed to confirm the user's intention to export only the application. If a yes button is operated, the export will be continued, and if a no button is operated, the export will be canceled. A screen 1705 illustrates an example of a screen to be displayed when the export of only the application has been completed. As illustrated in reference numeral 1706, something to the effect that a user operation will be necessary at the time of activation since only the application has been exported is displayed on the screen 1705.

A screen 1707 illustrates a screen to be displayed when the exported electronic scoring html 303 is activated. Since only the electronic scoring module 302 and the electronic scoring html 303 are exported, scoring data related to a test is not registered. Therefore, on the screen 1707, display requesting that a test be registered is performed, and a register test button 1708 for executing registration is displayed.

A screen 1709 illustrates a screen to be displayed when the register test button 1708 is operated. User input is required for a test name. Accordingly, data related to a test is searched for using a character string inputted in a test name input form 1710. In addition, since it is conceivable that there may be a user who wishes to cancel registration, a cancel button 1711 is provided on the screen 1709. By operating a next button 1712, it is possible to advance test registration processing. A screen 1713 illustrates an example of a top screen to be displayed after a test has been registered. Once a test has been registered, an added test 1714 is displayed in a selectable manner. By operating the added test 1714, it is possible to perform electronic scoring.

### <Export Processing>

### (Basic Flow)

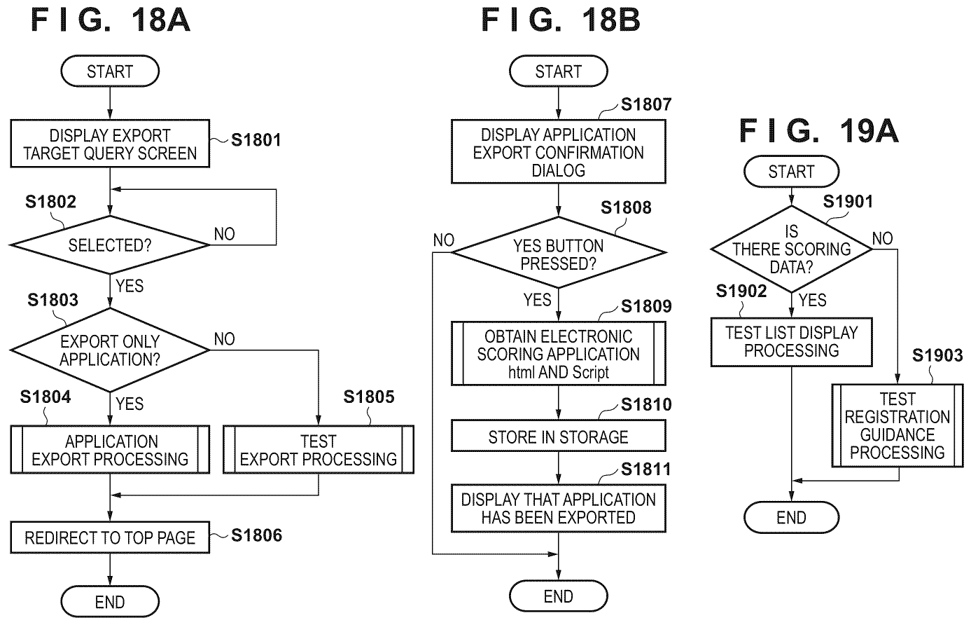

Next, a processing procedure at the time of operation of the export button 1002 of the screen 1000 according to the present embodiment will be described with reference to FIGS. 18A and 18B. FIG. 18A illustrates a procedure of processing to be performed when displaying the screen 1700. In this flow, processing for exporting externally from the multifunction peripheral 100 only the electronic scoring module 302 and the electronic scoring html 303 or, in addition to these files, scoring data and an answer sheet image of a test.

In step S1801, the CPU 113 displays the screen 1700 and advances the processing to step S1802. In step S1802, the CPU 113 determines whether either the button 1701 for exporting only the application or the button 1702 for exporting a test has been operated. If something has been operated, the processing proceeds to step S1803, and if nothing has been operated, the determination of step S1802 is performed periodically to wait for the user to operate a button.

In step S1803, the CPU 113 determines whether the button 1701 for exporting only the application has been operated. If that button has been operated, the processing proceeds to step S1804, and if a button other than that button has been operated, the processing proceeds to step S1805. In step S1804, the CPU 113 performs application export processing and advances the processing to step S1806. Details of the application export processing will be described later. In step S1805, the CPU 113 performs test export processing and advances the processing to step S1806. Since the test export processing has the same flow as that in FIG. 11C, description will be omitted. In step S1806, the CPU 113 transitions to the screen 1000 and ends the processing of this flowchart.

### (Application Export Processing)

FIG. 18B illustrates a processing procedure of the application export processing (step S1804). In this flow, processing for externally exporting only the electronic scoring module 302 and the electronic scoring html 303 is performed.

In step S1807, the CPU 113 displays the screen 1703 and advances the processing to step S1808. In step S1808, the CPU 113 determines whether a yes button has been operated on the screen 1703. If the yes button has been operated, the processing proceeds to step S1809, and if a button other than the yes button has been operated, the processing of this flowchart is terminated.

In step S1809, the CPU 113 obtains the electronic scoring module 302 and the electronic scoring html 303 from the ROM 102 of the multifunction peripheral 100 and advances the processing to step S1810. In step S1810, the CPU 113 stores the electronic scoring module 302 and the electronic scoring html 303 in the ROM 115 of the information device 110 and advances the processing to step S1811. In step S1811, the CPU 113 displays the screen 1705 and ends the processing of this flowchart.

<Activation of Electronic Scoring html>

### (Basic Flow)

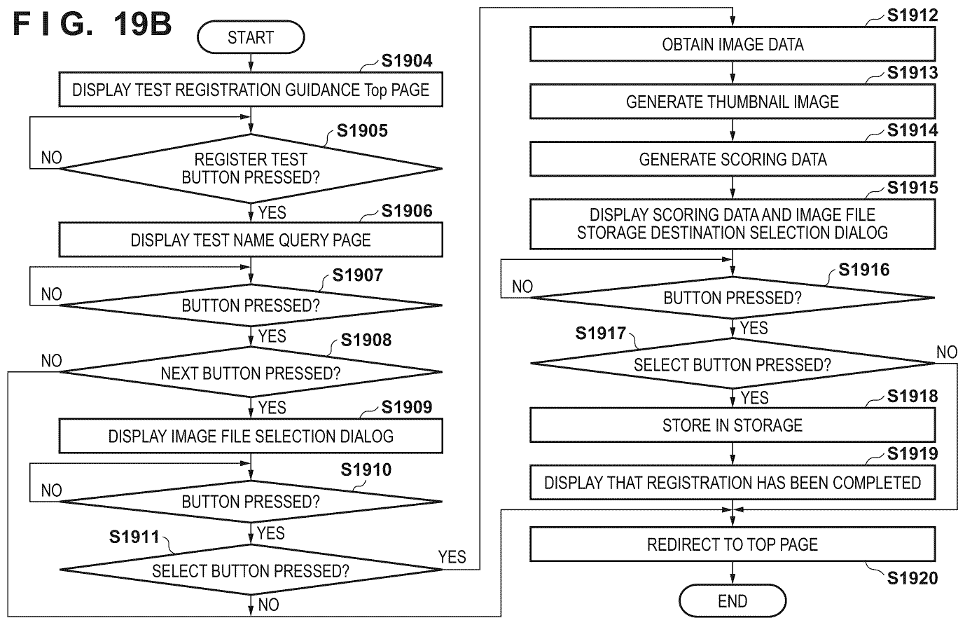

Next, a processing procedure for when the exported electronic scoring html 303 is activated will be described with reference to FIGS. 19A and 19B. FIG. 19A illustrates a processing procedure for when the exported electronic scoring html 303 is activated. In this flow, processing for drawing a top page, including a case where only the application has been exported and no test has been registered, is described.

In step S1901, the CPU 113 determines whether there is scoring data in the same directory as that of the electronic scoring html 303. If there is scoring data, the processing proceeds to step S1902, and if there is no scoring data, the processing proceeds to step S1903. In step S1902, the CPU 113 performs test list display processing and ends the processing of this flowchart. Since the test list display processing has the same flow as that in FIG. 11A, description will be omitted. In step S1903, the CPU 113 performs test registration guidance processing and ends the processing of this flowchart. Details of the test registration guidance processing will be described later.

### (Test Registration Guidance Processing)

FIG. 19B illustrates a processing procedure of the test registration guidance processing (step S1903). In this flow, processing for registering answer sheet image data stored in the user's information device 110 as data to be scored is performed.

In step S1904, the CPU 113 displays the screen 1707 and advances the processing to step S1905. In step S1905, the CPU 113 determines whether the register test button 1708 has been operated. If that button has been operated, the processing proceeds to step S1906, and if that button has not been operated, the processing proceeds to step S1905 to wait for the user to operate a button.

In step S1906, the CPU 113 displays the screen 1709 and advances the processing to step S1907. In step S1907, the CPU 113 determines whether a button has been operated. If a button has been operated, the processing proceeds to step S1908, and if a button has not been operated, the determination of step S1907 is performed periodically to wait for the user to operate a button.

In step S1908, the CPU 113 determines whether the next button 1712 has been operated. If that button has been operated, the processing proceeds to step S1909, and if a button other than that button has been operated, the processing proceeds to step S1920. In step S1909, the CPU 113 displays an image file selection dialog and advances the processing to step S1910. Regarding the selection dialog, an OS native dialog or a standard dialog of a browser 112 need only be displayed.

In step S1910, the CPU 113 determines whether a button has been operated. If a button has been operated, the processing proceeds to step S1911, and if a button has not been operated, the determination of step S1910 is performed periodically to wait for the user to operate a button. In step S1911, the CPU 113 determines whether a file selection button has been operated. If the file selection button has been operated, the processing proceeds to step S1912, and if a button other than the file selection button has been operated, the processing proceeds to step S1920.

In step S1912, the CPU 113 obtains the selected image data and advances the processing to step S1913. In step S1913, the CPU 113 generates a thumbnail image from the selected image data and advances the processing to step S1914. As a thumbnail image generation method, a thumbnail image can be generated using a method such as that in which a first image in the selected image data is read as an html canvas element and then resized. In step S1914, the CPU 113 generates scoring data using the obtained test name, image data, and thumbnail image and advances the processing to step S1915. Scoring data may be generated using a method such as that described in the above-described electronic scoring preprocessing (step S802).

In step S1915, the CPU 113 displays a dialog for selecting a storage destination of the scoring data, the image data, and the thumbnail image and advances the processing to step S1916. Regarding the selection dialog, an OS native dialog or a standard dialog of the browser 112 need only be displayed. In step S1916, the CPU 113 determines whether a button has been operated. If a button has been operated, the processing proceeds to step S1917, and if a button has not been operated, the determination of step S1916 is performed periodically to wait for the user to operate a button.

In step S1917, the CPU 113 determines whether a storage destination selection button has been operated. If the storage destination selection button has been operated, the processing proceeds to step S1918, and if a button other than the storage destination selection button has been operated, the processing proceeds to step S1920. In step S1918, the CPU 113 stores the scoring data, image data, and the thumbnail image in the designated storage destination and advances the processing to step S1919. In step S1919, the CPU 113 displays that registration has been completed and advances the processing to step S1920. In step S1920, the CPU 113 transitions to the screen 1000 and ends the processing of this flowchart.

As described above, upon receiving a predetermined instruction according to a user operation, the image processing apparatus according to the present embodiment outputs the scoring module and the operation module. This makes it possible to output only the electronic scoring module 302 for performing the electronic scoring processing and the electronic scoring html 303 for displaying a screen for electronic scoring and receiving a user operation from the multifunction peripheral 100 without outputting image data. Further, it is possible to realize control for registering data related to a test to be electrically scored in the outputted electronic scoring module 302 and the electronic scoring html 303 will be described.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-116925, filed Jul. 18, 2023, which is hereby incorporated by reference herein in its entirety.

What is claimed is:

1. An image processing apparatus comprising:
an obtaining unit configured to obtain a scoring module that executes electronic scoring processing and an operation module that displays a screen for electronic scoring and accepts a user operation;
a reading unit configured to read an answer sheet to be electronically scored; and
an output unit configured to output image data read by the reading unit and output data including the scoring module and the operation module.

2. The image processing apparatus according to claim 1, wherein
the output data further includes scoring data for holding a scoring result.

3. The image processing apparatus according to claim 2, wherein
the output unit outputs the output data to an external memory or to an external apparatus via a network.

4. The image processing apparatus according to claim 2, further comprising:
an import unit configured to import a set of data including the image data and scoring data corresponding to the image data from an external apparatus into the image processing apparatus.

5. The image processing apparatus according to claim 4, wherein
in a case where a set of data that overlaps with the set of data to be imported is held in the image processing apparatus, the import unit queries as to whether to continue the import.

6. The image processing apparatus according to claim 5, wherein
in a case where a difference is included in the set of data to be imported from the external apparatus and the set of data held in the image processing apparatus, the import unit determines whether to continue the import based on a user operation.

7. The image processing apparatus according to claim 4, wherein
in a case where a set of data that overlaps with the set of data to be imported is held in the image processing apparatus, the import unit respectively merges each item of the scoring data included in the sets of data.

8. The image processing apparatus according to claim 7, wherein
in a case where performing merging for the difference in each item of the scoring data, the import unit selects data to be prioritized according to a user operation.

9. The image processing apparatus according to claim 4, further comprising:
a display control unit configured to display the image data held in the image processing apparatus and a set of data including scoring data corresponding to the image data so as to be selectable, wherein
the output unit outputs the set of data to an external apparatus selected according to a user operation.

10. The image processing apparatus according to claim 9, wherein
upon receiving a predetermined instruction according to a user operation, the output unit outputs the scoring module and the operation module.

11. The image processing apparatus according to claim 1, wherein
the obtaining unit obtains the scoring module and the operation module from a memory of the image processing apparatus or from an external apparatus via a network.

12. The image processing apparatus according to claim 11, wherein
the scoring module is generated in a script file format, and
the operation module is generated in a hypertext markup language (html) file format.

13. A method of controlling an image processing apparatus, the method comprising:
obtaining a scoring module that executes electronic scoring processing and an operation module that displays a screen for electronic scoring and accepts a user operation;
reading an answer sheet to be electronically scored; and
outputting image data read in the reading and outputting data including the scoring module and the operation module.

14. A non-transitory computer-readable storage medium storing one or more programs including instructions, which when executed by one or more processors of an image processing apparatus, cause the image processing apparatus to perform:
obtaining a scoring module that executes electronic scoring processing and an operation module that displays a screen for electronic scoring and accepts a user operation;
reading an answer sheet to be electronically scored; and
outputting image data read in the reading and outputting data including the scoring module and the operation module.
